(19) United States
(12) Patent Application Publication
(10) Pub. No.: US 2002/0147646 A1
(43) Pub. Date: Oct. 10, 2002

(54) Advertisement transmitting system

(75) Inventors: Kazuhiro Ogura, Kawasaki-shi (JP); Akinori Iwase, Yokosuka-shi (JP); Tatsuya Haraguchi, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/084,636

(22) Filed: Feb. 28, 2002

(30) Foreign Application Priority Data
Mar. 2, 2001 (JP) 2001-058995

(51) Int. Cl. G06F 17/60

(52) U.S. Cl. 705/14

(57) ABSTRACT

A head shop server transmits an advertisement statement (handbill) to a user's portable telephone set via Internet. The advertisement statement is displayed at the portable telephone set by the user's E-mail receiving operation, and an advertisement document to be linked with the advertisement statement can be instructed to be printed to a printing sever via Internet by operation of the portable telephone set. The printing server stores the instructed advertisement document data, and transmits the advertisement document data via Internet in response to a print request from an MFP via Internet. The MFP prints the advertisement document based on the received advertisement document data.

### CROSS-REFERENCE TO RELATED APPLICATIONS

This application is based upon and claims the benefit of priority from the prior Japanese Patent Application No. 2001-058995, filed Mar. 2, 2001, the entire contents of which are incorporated herein by reference.

### BACKGROUND OF THE INVENTION

1. Field of the Invention

The present invention relates to an advertisement transmitting system that makes communication with a portable terminal such as a portable telephone set capable of receiving E-mail, thereby transmitting an advertisement statement, and printing an advertisement document.

2. Description of the Related Art

Conventionally, a large effort has been made to produce advertisement documents such as newspaper advertisement or handbills which are advertisements at shop. However, in handbills of newspaper as well, although advertisement in which profiles of a user have been narrowed (such as location when a user lives or type of newspaper) can be carried out, it has been difficult to promote advertisement by focusing on individual users.

Recently, a direct mail (hereinafter, described as a DM) targeted for each user is utilized because of its efficiency such as one-to-one marketing. However, the DM using a mail is very large in cost such as a mailing cost or a production cost including print cost. In addition, the DM using a mail includes a time lag of several days such as print time or mailing time. Thus, there has been a large problem that a shop cannot advertise desired item timely.

In addition, Japanese Patent Application Laid-open No. 2000-357071 is directed to an invention concerning a kiosk system for printing information disclosed via Internet or the like or the user data. In this invention as well, although printing advertisements is mentioned, advertisement cannot be actively carried out. The DM includes information on individual users. Even when it is required to identify a user during printing, and then, print information oriented to that user, this system cannot generate information during printing at information media, and individual oriented information cannot be printed. On the other hand, information print oriented to individuals has a system of printing the user data. However, in this system, dispatched information is fixedly stored by a printing server, and thus, information required at that time cannot be dispatched.

In addition, Japanese Patent Application Laid-open No. 2000-206916, there is described a method for displaying an advertisement for a portable terminal device. However, the only thing is that one expects that a user sees information displayed on a clock screen for a portable terminal. Thus, timely effective advertisements cannot be carried out when one thinks so.

Further, in Japanese Patent Application Laid-open No. 2000-224658, a message narrowing an area can be dispatched to a portable terminal. With respect to a time, although a sufficient effect can be expected, the same message is transmitted to an unspecified majority. Thus, an effect targeted for individuals cannot be expected.

### BRIEF SUMMARY OF THE INVENTION

It is an object of the present invention to provide an advertisement transmitting system capable of preventing generation of a delay time such as a printing time or a mailing time, and printing a required transmission and a required advertisement document whenever necessary.

In order to achieve the foregoing object, according to the present invention, there is provided an advertisement transmitting system in which a first device for making communication with a portable terminal, a second device having print data registered therein, and a printer device having a communication function and carrying out printing are connected to each other via a communication line, wherein the first device has: a storage section for storing advertisement information for producing an advertisement that contains image information; a production section for producing advertisement data that contains advertisement document information to be transmitted to the portable terminal by using advertisement information stored in the storage section; and a transmission section for transmitting advertisement data produced by the production section to the portable terminal via the communication line; the second device comprises a receiving section for receiving a request for printing an advertisement document contained in the advertisement data from the portable terminal via the communication line; an acquiring section for acquiring print data that corresponds to a request for printing an advertisement document received at the receiving section from advertisement information stored in the storage section via the communication line; and a registering section for registering print data acquired by the acquiring section, and the printer device is composed of: an accepting section for accepting a request for printing the advertisement document; a readout section for reading out print data registered in the registering section according to a request for printing an advertisement document received by the accepting section; and a printing section for printing print data read out by the readout section.

### BRIEF DESCRIPTION OF THE SEVERAL VIEWS OF THE DRAWING

FIG. 1 is a general configuration of a network system according to an embodiment of the present invention;

FIG. 2 is a block diagram depicting a general configuration of a portable telephone set;

FIG. 3 is a block diagram depicting a general configuration of a printing server;

FIG. 4 is a block diagram depicting a general configuration of a head shop server;

FIG. 5 is a block diagram depicting a general configuration of a CRM section;

FIG. 6 is a block diagram depicting a general configuration of a digital multifunctional peripheral (MFP);

FIG. 7 is a view showing an exemplary configuration of a printing module management database;

FIG. 8 is a view showing another exemplary configuration of the printing module management database;

FIG. 9 is a view showing an exemplary configuration of a device ID database;

FIG. 10 is a view showing another exemplary configuration of a device ID database;

FIG. 11 is a view showing an exemplary configuration of a document IDX database;

FIG. 12 is a view showing an arrangement for storing a file by using a document DAT database;

FIG. 13 is a view showing an exemplary configuration of a printing server user management database;

FIG. 14 is a view showing an exemplary configuration of an accounting database;

FIG. 15 is a view showing an exemplary configuration of an accounting database;

FIG. 16 is a view showing an exemplary configuration of an accounting database;

FIG. 17 is a view showing an exemplary configuration of an accounting database;

FIG. 18 is a view showing an exemplary configuration of an accounting database;

FIG. 19 is a view showing an exemplary configuration of a report packet;

FIG. 20 is a view showing an exemplary configuration of a payer ID management database;

FIG. 21 is a view showing an exemplary configuration of a head shop user management database;

FIG. 22 is a view showing an exemplary configuration of an advertisement database;

FIG. 23 is a view showing an exemplary configuration of a delivery history table;

FIG. 24 is a view showing an exemplary configuration of a delivery product master;

FIG. 25 is a view showing an exemplary configuration of a coupon database;

FIG. 26 is a view showing an exemplary configuration of an advertisement history table;

FIG. 27 is a view showing an exemplary configuration of an advertisement parts table;

FIG. 28 is a view showing an exemplary configuration of a layout table;

FIG. 29 is a view showing an exemplary configuration of a layout;

FIG. 30 is a view showing an exemplary configuration of a layout;

FIG. 31 is a view showing an exemplary configuration of a ticket database;

FIG. 32 is a view showing an exemplary configuration of a cache preceding transmission buffer;

FIG. 33 is a view showing an exemplary configuration of a shop internal advertisement database;

FIG. 34 is a view showing an exemplary configuration of a shop internal advertisement;

FIG. 35 is a view showing an exemplary configuration of an unregistered person oriented advertisement database;

FIG. 36 is a view showing an exemplary configuration of a printing module management database;

FIG. 37 is a view showing another exemplary configuration of a printing module management database;

FIG. 38 is a view showing an exemplary configuration of a cassette information database;

FIG. 39 is a view illustrating paper to be set to a cassette;

FIG. 40 is a view illustrating paper to be set to a cassette;

FIG. 41 is a view illustrating paper to be set to a cassette;

FIG. 42 is a view showing an exemplary configuration of a temporary storage buffer;

FIG. 43 is a view illustrating a first operation for registering an advertisement document in a printing server;

FIG. 44 is a view illustrating a second operation for registering an advertisement document in a printing server;

FIG. 45 is a view illustrating a third operation for registering an advertisement document in a printing server;

FIG. 46 is a view illustrating an operation for instructing print by operation from an MPF touch panel;

FIG. 47 is a view showing an example of an advertisement document printed by a printer;

FIG. 48 is a flow chart illustrating a printing operation using a printer;

FIG. 49 is a view showing an example of an acquired advertisement document;

FIG. 50 is a view showing an error display example;

FIG. 51 is a view showing an example of notifying no paper to be transmitted to a clerk's portable telephone set;

FIG. 52 is a flow chart illustrating an operation for determining a cassette;

FIG. 53 is a flow chart illustrating an operation for acquiring a layout;

FIG. 54 is a flow chart illustrating an operation for acquiring parts;

FIG. 55 is a flow chart illustrating an operation for printing a coupon;

FIG. 56 is a view illustrating a printing operation by providing access from a portable telephone set;

FIG. 57 is a flow chart illustrating an operation for printing an advertisement document;

FIG. 58 is a view showing a message example displayed at a display section;

FIG. 59 is a view showing an example when data (document) is displayed as a print history;

FIG. 60 is a view illustrating an operation for instructing print by inputting a printer number;

FIG. 61 is a flow chart illustrating an operation for checking identification of a coupon user;

FIG. 62 is a view showing an external configuration of a bar code reader device;

FIG. 63 is a view showing an example of a coupon printed in an advertisement document;

FIG. 64 is a view showing an example of a printed ticket;

FIG. 65 is a view showing an example of a membership registration card;

FIG. 66 is a view showing a document example as sample data; and

FIG. 67 is a view showing a message display example.

### DETAILED DESCRIPTION OF THE INVENTION

Hereinafter, preferred embodiments of the present invention will be described with reference to the accompanying drawings.

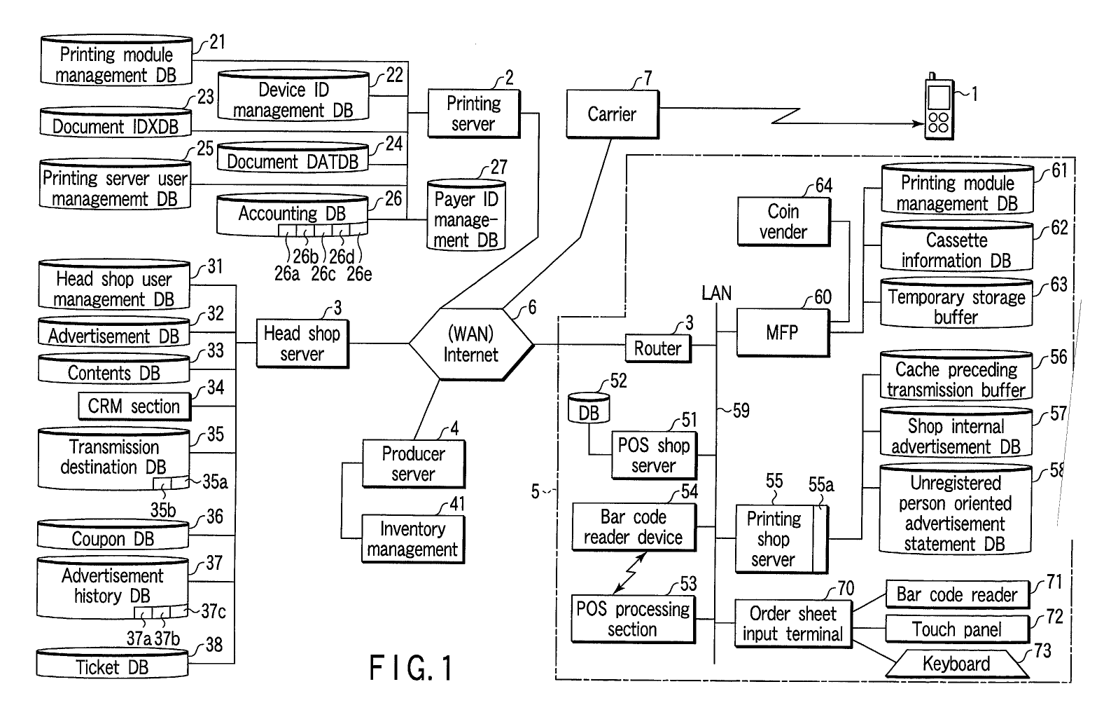

FIG. 1 is a view showing a general configuration of a network system according to an advertisement transmitting system of the present invention. As shown in FIG. 1, the network system is composed of: a portable telephone set (portable telephone terminal) 1; a printing server 2; a head shop server 3; a producer server 4; a shop 5; and a communication Internet 6 connecting them. Another network such as WAN (Wide Area Network) can be used instead of Internet.

In this network system, although one head shop server is provided, this server may be provided in plurality. A producer server is actually provided in plurality, and a plurality of head shops are configured to have a plurality shops, respectively. In the present embodiment, a description is complicated, and thus, the head shop server, producer server, and shop are integrated.

The portable telephone set 1 makes connection with Internet 6 via a carrier 7, thereby transmitting/receiving data. In this manner, the portable telephone 1 can receive an E-mail (hereinafter, referred to as “mail”). Although the present embodiment has described the portable telephone 1 as a portable terminal, a portable terminal capable of receiving an E-mail such as portable mail terminal or PDA (personal digital assistant) can be used similarly.

The printing server 2 is provided as a server device composed of a personal computer (PC). This printing server 2 has: a printing module management database (DB) 21; a device ID management database (DB) 22; a document IDX database (DB) 23; a document DAT database (DB) 24; a printing server user management database (DB) 25; and an accounting database (DB) 26.

The head shop server 3 is provided as a server device composed of a personal computer (PC) or the like. This server produced and manages data, and transmits data to the shop 5. This head shop server 3 has a head shop user management database (DB) 31; an advertisement database (DB) 32; a contents database (DB) 33; a CRM (customer relation management) section 34 which will be described later in detail; a delivery destination database (DB) 35; a coupon database (DB) 36; an advertisement statement history database (DB) 37; and a ticket database (Db) 38.

The producer server 4 is provided as a server device composed of a personal computer (PC) or the like. An inventory management database (DB) 41 for managing inventory is connected to this server.

The shop 5 is composed of: a router 50 connected to Internet 6; a POS shop server 51; a POS processing section 53; a printing shop server 55; a digital multifunctional peripheral (MFP) 60 and an order document input terminal 70; and a shop internal LAN 59 connected them.

The POS shop server 51 is provided as a server device composed of a personal computer (PC) as a point of sales information management system (point of sales). The database (DB) 52 storing a variety of information is connected to the server.

The POS processing section 53 processes information read by a bar code reader device 54 as a point of sales information management system (point of sales).

The printing shop server 55 is provided as a server device composed of a personal computer (PC) or the like. A built-in hard disk device (HDD) 55a stores a cache preceding transmission buffer database (DB) 56; a shop internal advertisement database (DB) 57; and an unregistered person oriented advertisement statement database (DB) 58.

The digital multifunctional peripheral 60 has a printing device (printer) and an image reader device (scanner). The digital multifunctional peripheral 60 has a module management database (DB) 61, a cassette information database (DB) 62, and a temporary storage buffer 63. In addition, the digital multifunctional peripheral 60 has a coin bender 64 used for accounting connected thereto.

The order document input terminal 70 is provided as a terminal device composed of a personal computer (PC). A bar code reader 71, a touch panel 72 having a display section such as a liquid crystal display and carrying out input, and a keyboard 73 are connected to the terminal device.

Now, a configuration of the portable telephone set 1 will be described here.

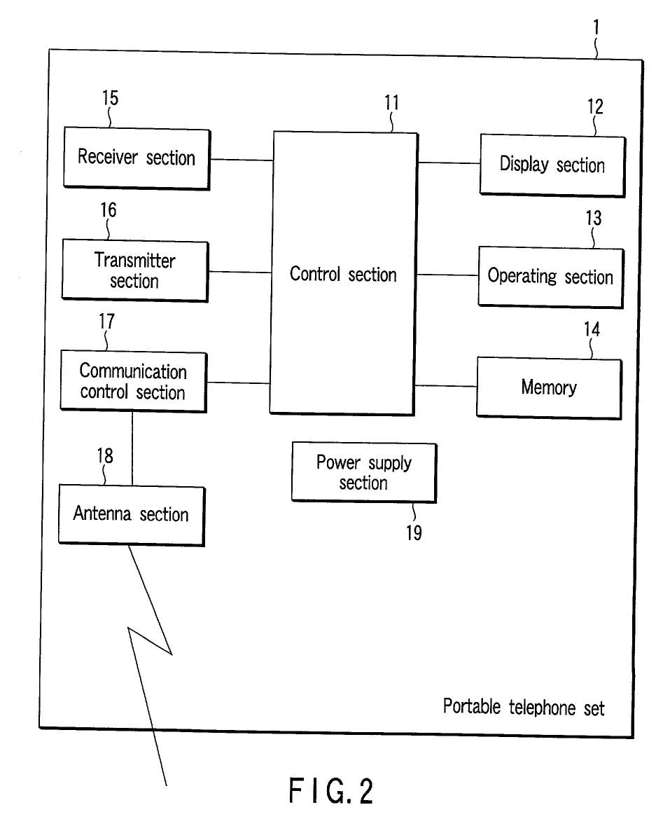

FIG. 2 is a block diagram depicting a general configuration of the portable telephone set. As shown in FIG. 2, the portable telephone set 1 has a control section 11, a display section 12, an operating section 13, a memory 14, a receiver section 15, a transmitter section 16, a communication control section 17, an antenna section 18, and a power supply section 19.

The control section 11 controls the entirety of the portable telephone set 1. The display section 12 is composed of a liquid crystal display, and a variety of messages are displayed. The operating section 13 is composed of a variety of keys such as ten numeric keys and cursor keys, and inputs an operational instruction.

The memory 14 is composed of: a storage section for storing preset data such as a control program or user information; and a storage section for temporarily storing a variety of information or control data. The receiver section 15 is provided as a speaker for generating a voice when one makes conversation by using a telephone function. The transmission section 16 is provided as a microphone for inputting a voice when one makes conversation by using a telephone function.

The communication control section 17 is provided as an interface for controlling communication with an external device by using the above antenna section 18. The above power supply section 19 is composed of a battery or the like so as to supply power to each section of the portable telephone set 1.

Now, a configuration of the printing server 2 will be described here.

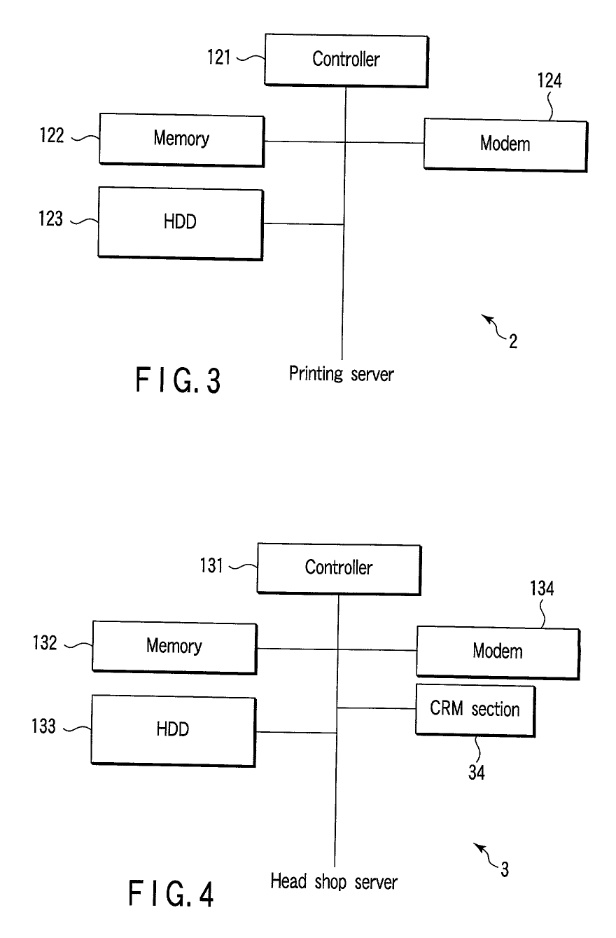

FIG. 3 is a view showing a general configuration of the printing server 2. As shown in FIG. 3, the printing server 2 has a controller 121, a memory 122, a hard disk drive (HDD) 123, and a modem 124 or the like.

The controller 121 uses a CPU. This controller 121 controls an operation of the entire printing server 2, and operates in accordance with a program that is stored in advance. The memory 122 is used to temporarily store a variety of information or control data and the like when the controller 121 operates.

The HDD 123 stores a variety of data, and stores preset information or the like when the printing server 2 operates. In addition, this HDD 123 stores a printing module management DB 21 described above, a device ID management DB 22, a document IDXDB 23, a document DATDB 24, a printing server user management DB 25, and an accounting DB 26. The modem 24 is provided as an interface for making connection to Internet 6.

Now, a configuration of the head shop server 3 will be described here.

FIG. 4 is a view showing a general configuration of the head shop server 3. As shown in FIG. 4, the head shop server 3 has a controller 131, a memory 132, a hard disk driver (HDD) 133, a modem 134, and the above-described CRM 34 or the like.

The controller 131 uses a CPU. This controller 131 controls an operation of the entire head shop server 3, and operates in accordance with a program that is stored in advance. The memory 132 is used to temporarily store a variety of information or control data and the like when the controller 131 operates. The HDD 133 stores a variety of data such as a file. This HDD 133 stores the above described head shop user management DB 31, an advertisement DB 32, a contents DB 33, a delivery destination DB 35, a coupon DB 36, an advertisement statement history DB 37, and a ticket DB 38. The modem 134 is provided as an interface for making connection to Internet 6.

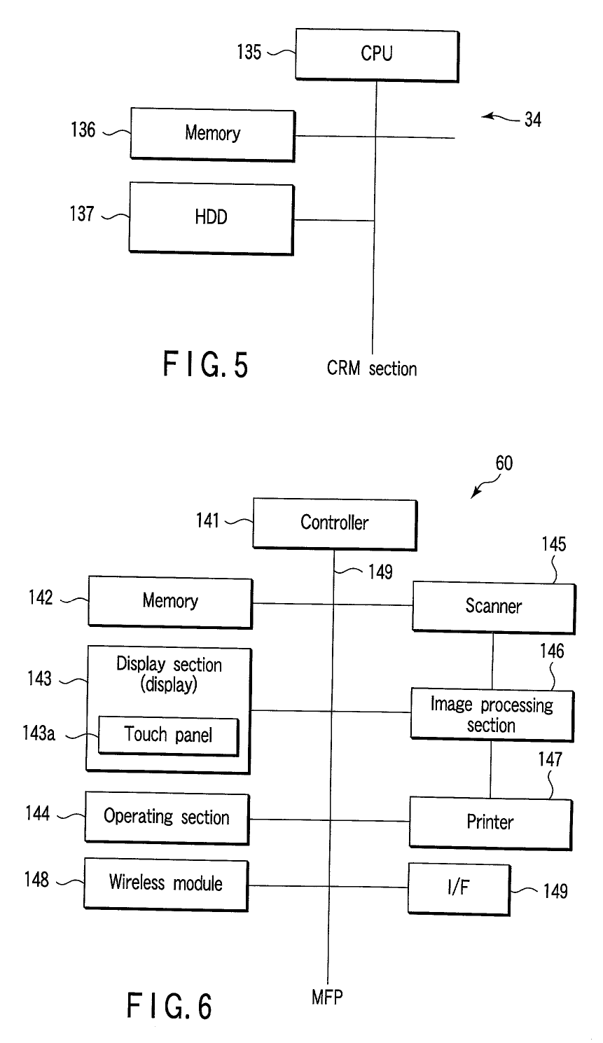

FIG. 5 is a view showing a general configuration of a CRM section 34. The CRM section 34 has: a CPU 135 for controlling the entire operation; a memory 136 used to temporarily store a variety of information or control data and the like; and a hard disk drive (HDD) 137 for storing a variety of data such as a file.

Now, a general configuration of the digital multifunctional peripheral (MFP) 60 will be described here.

FIG. 6 is a view showing a general configuration of the digital multifunctional peripheral 60. As shown in FIG. 6, the digital multifunctional peripheral 60 has a controller 141, a memory 142, a display section (display) 143, an operating section 144, a scanner 145, an image processing section 146, a printer 147, a wireless module 148, and an interface (I/F) 149 or the like. The above constituent elements each are connected to each other via a bus 149 around the controller 141.

The controller 141 uses a CPU. This controller 141 controls an operation of the entire digital multifunctional peripheral 60, and operates in accordance with a program that is stored in advance.

The memory 142 has a ROM and a RAM or the like, and is used to store a variety of information or control data and the like when the controller 141 operates. In addition, the memory 142 has a hard disk, for example, and stores the above-described module management DB 61, a cassette information DB 62, and a temporary storage buffer 63.

The display section 143 is provided as a display composed of a liquid crystal display device incorporating in a touch panel 143a therein. The operating section 144 is composed of hardware keys such as ten numeric keys, cursor keys, and copy start key. A variety of operations in the digital multifunctional peripheral 60 are carried out by the hard keys serving as this operating section 144 and a touch panel 143a.

The scanner 145 optically scans a document, and changes the document to image data. The image processing section 146 carries out a variety of processing for image data. The printer 147 prints image data on paper. Various types such as photoelectric type and ink jet type are available for the printer 147. In the present embodiment, a printer of such photoelectric type is used.

The wireless module 63 makes wireless communication such as bluetooth with the portable telephone set 1.

The interface 149 is intended to make connection to the shop internal LAN 59.

Now, a database managed by the printing server 2 will be described here.

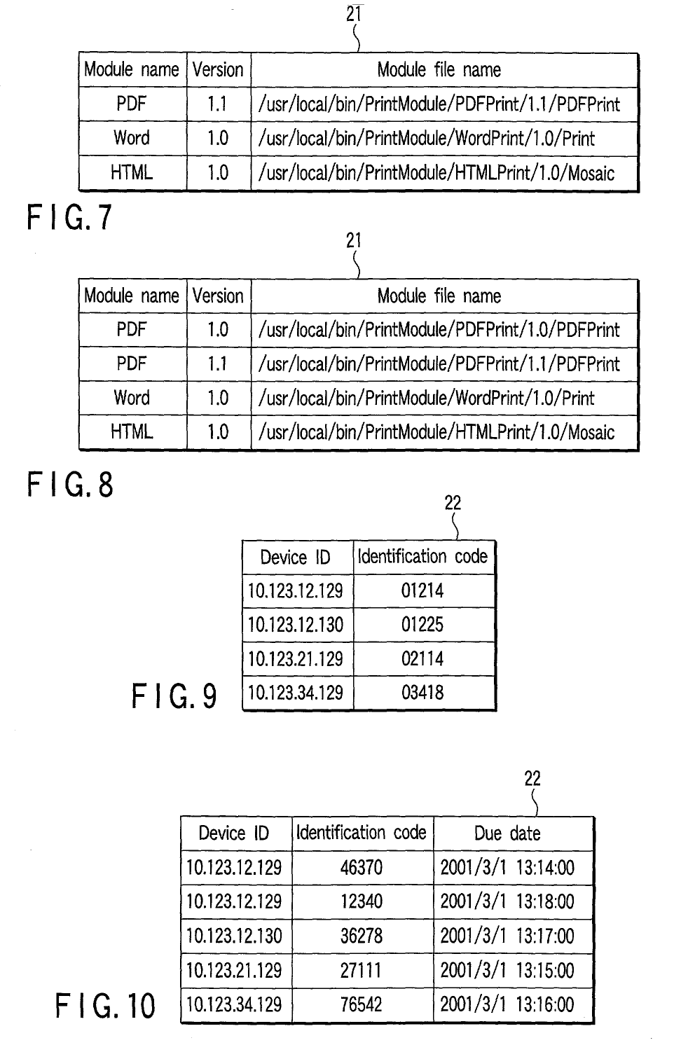

FIG. 7 is a view showing an exemplary configuration of the printing module management DB 21 stored in the HDD 123 of the printing server 2. This printing module management DB 21 is composed of a module name, a version, and a module file name. Here, only the latest version is stored for each module. For example, the module name is “PDF”, the version is “1.1”, and the module file name is “/usr/local/bin/PrintModule/PDFPrint/1.1/PDFPrint”.

FIG. 8 is a view showing another exemplary configuration of the printing module management DB 21 stored in the HDD 123 of the printing server 2. This printing module management DB 21 is composed of: a module name, a version, and a module file name. Here, all the available modules and their versions are stored. For example, the module name is stored as “PDF”, the version is stored as “1.0”, and the module file name is stored as “/usr/local/bin/PrintModule/PDFPrint/1.0/PDFPrint”. The version “1.1” is stored as well.

FIG. 9 is a view showing an exemplary configuration of the device ID management DB 22 stored in the HDD 123 of the printing server 2. This device ID management DB 22 holds a relationship between the identification code and device ID assigned to the MFP 60. In the present embodiment, as a device ID, an IP address of the controller 141 in the MFP 60 is used. For example, the device ID is “10. 123. 12. 129” that is an IP address of the controller 141. The identification code “01214” is assigned to the MFP 60 of this device ID “10. 123. 12. 129.

FIG. 10 is a view showing another exemplary configuration of the device ID management DB 22 stored in the HDD 123 of the printing server 2. This device ID management DB 22 holds the device ID, identification code assigned at the current time, and validity of this identification code for each MFP 60. For example, the identification code “46370” is assigned to the MFP 60 of the device ID “10. 123. 12. 129”, and the validity is held as “2000/3/1 13:14:00”.

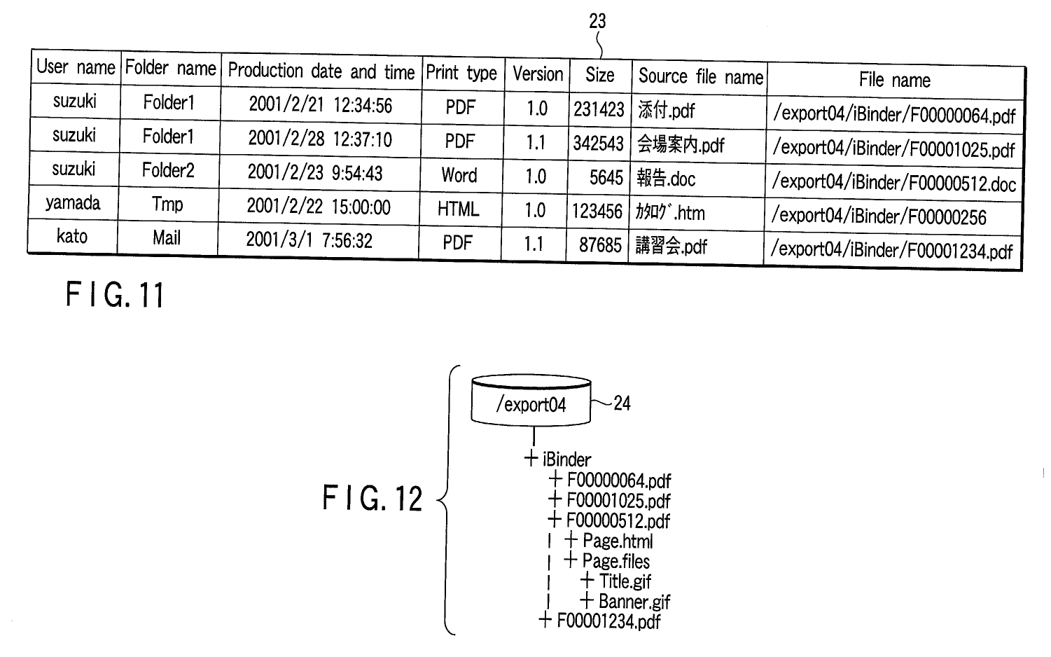

FIG. 11 is a view showing an exemplary configuration of the document IDXDB 23 stored in the HDD 123 of the printing server 2. This document IDXDB 23 stores one record including: a user name that is a document owner, a folder name, production date and time (storage date and time to module server 2), printing type (module type), version (module version), data size, a source file name, and a file name on the printing server 2 for each item of document data. For example, stored are: the user name “suzuki”; the folder name “Folder 1”; the production date and time “2000/2/21 12:34:56”; the printing type “PDF”; the version “1.0”; the size “231423”; the source file name “attached.pdf”, and the file name “/export04/iBinder/F00000064.pdf”.

FIG. 12 shows a configuration for storing a file in the document DATDB 24 of the printing server 2. Where print data is stored in one file, it is stored as a file as is, and its path is stored as a file name shown in FIG. 11. If print data consists of a plurality of files, a folder is produced for storing print data, and a file name is stored in this folder. In this folder, print data is stored so that the data can be printed by the MFP 60.

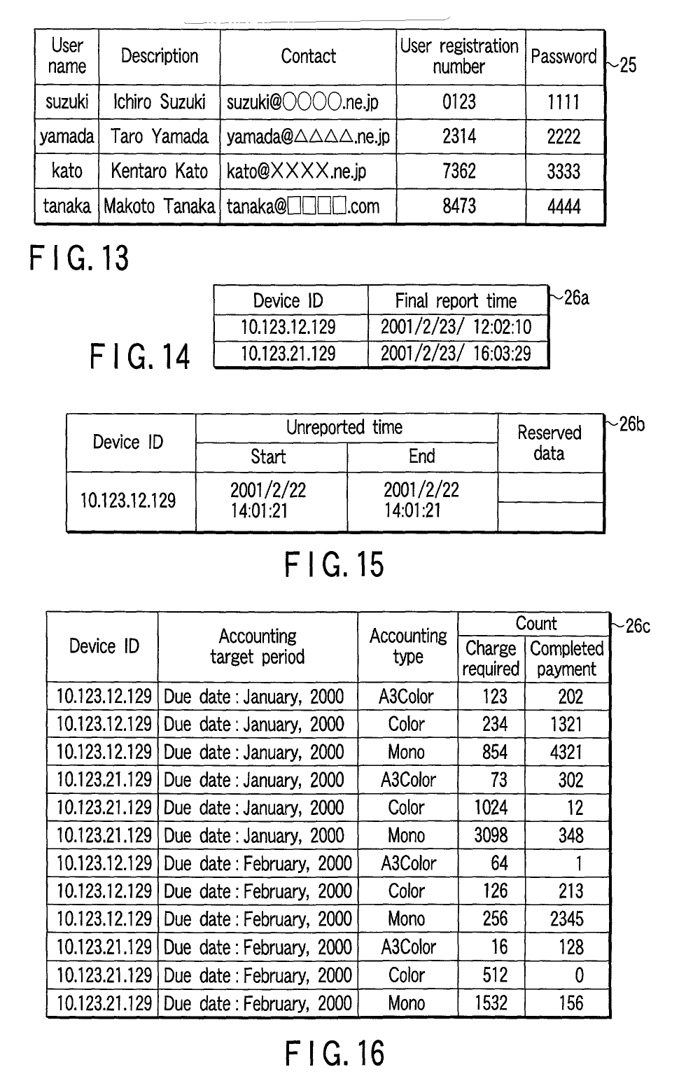

FIG. 13 is a view showing an exemplary configuration of the print server user management DB 25 stored in the HDD 123 of the print server 2. In the print server 2, this print server user management DB 25 is provided as a database for managing a user that receives this printing service. For each user, the user name (ID), description, contact (E-mail address of portable telephone set), user registration number, and password are stored. For example, for the user name “suzuki”, the description “ishiro suzuki”, contact “suzuki@docomo.ne.jp”, user registration number “0123”, and password “1111” are registered.

The user registration number requires input of user ID when this MFP 60 is used from the portable telephone set or the touch panel 143a of the MFP 60. In this case, alphabetical input from the portable telephone set 1 is very high in cost, and the user ID consists of only numerals that can be used instead of such input. Only the user registration number may be used instead of the user ID.

FIG. 14 to FIG. 18 are views each showing an exemplary configuration of an accounting DB 26 stored in the HDD 123 of the printing server 2.

First, FIG. 14 shows a table 26a of the final report history in the accounting DB 26. This final report history table 26a holds the last time of the accounting information notified for each MFP 60. This table is composed of device ID and final report time. For example, the MFP 60 of the device ID “10. 123. 12. 129” holds the final report time as “2001/2/23 12:02:10”.

FIG. 15 shows an unreported time table 26b in the accounting DB 26. If a time slot is not notified for each MFP 60, this unreported time table 26b holds it as a start time or end time, and further, stores reserved data as well. The unreported time table 26b is composed of the device ID, start and end of unreported time, and reserved data. For example, the MFP 60 of the device ID “10. 123. 12. 129” is stored as “2001/2/22 14:01:21” and the end of unreported time is stored as “2001/2/22 14:01:21”.

FIG. 16 shows an accounting counter counting table 26c in the accounting DB 26. This accounting counter counting table 26c counts the number of paper pieces printed by the MFP 60 for each accounting target period (for example, one month). At this time, for each accounting type, there are stored: the number of paper pieces printed free for the purpose of advertisement or the number of paper pieces paid by the coin vender 64 or the portable telephone set 1 and credit card or the like. That is, the accounting counter counting table 26c is composed of device ID, accounting target period, accounting type, and required charge in counting or completed payment. For example, the MFP 60 of the device ID “10. 123. 12. 129” holds the accounting target period “due date of January, 2001”, accounting type “A3Color”, and required charge in counting “123”, and completed payment in counting “202”.

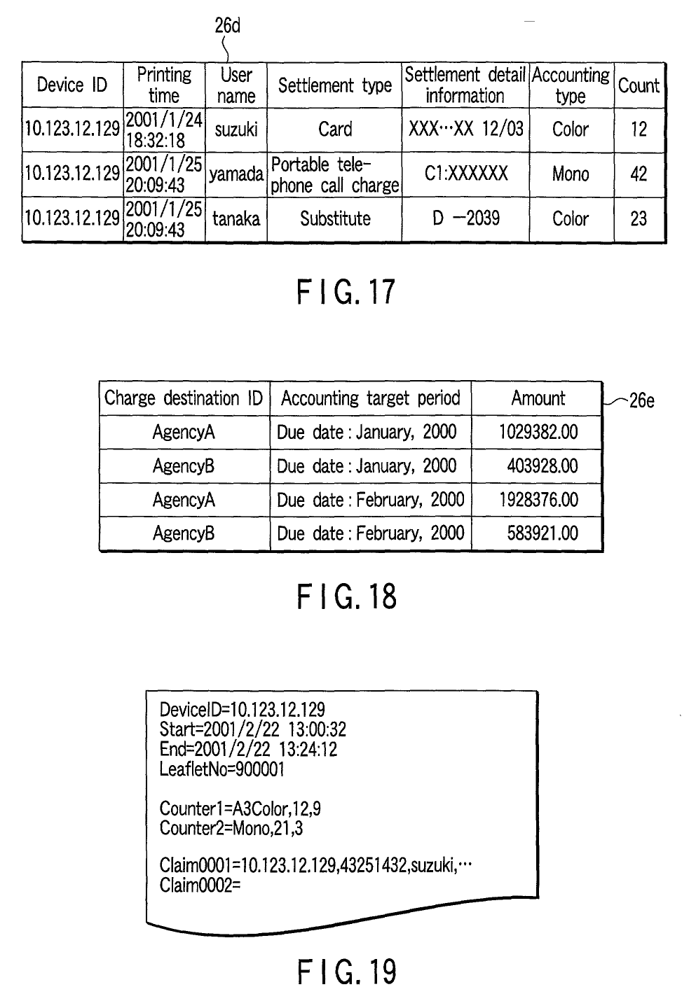

FIG. 17 shows a user charge detail table 26d in the accounting DB 26. When a user uses the MFP 60, when printing contents the user must pay a printing cost and when not making direct payment to a shop at the coin vender 64 or the like, the settlement history is managed in the user charge detail table 26d (the user is charged based on this history).

Thus, the user charge detail table 26d stores one record including the printing time, user name (ID), settlement type, settlement detail information, accounting type, and counting for the device ID every use. If printing with different accounting types is carried out by one use, it is stored separately twice. In this case, the same items of information other than accounting type and counting are stored. For example, the MFP 60 of the device ID “10. 123. 12. 129” stores the printing time “2001/1/24 18:32:18”, user name “suzuki”, settlement type “card”, settlement detail information “XXX . . . XX12/03”, accounting type “Color”, and counting “12”.

FIG. 18 shows an accounting count table 26e in the accounting DB 26. This accounting counting table 26e holds an amount of money for each accounting target period for the charge destination ID. For example, the accounting target period “due date of January, 2001” and the amount of money “1029382. 00” Yen are hold for the charge destination ID “Agency A”.

Uses such as prepaid card issued at a shop or a chain shop, credit card through a card reader (not shown), or debit card settlement are processed in a system on this settlement, and thus, such uses can be regarded as being directly paid.

FIG. 19 shows an exemplary configuration of a report packet. This report packet is not provided as data stored in the accounting DB 26, but is stored in the “reserved data” field for the unreported time table 26b.

That is, the report packet is used when accounting information is reported from the MFP 60 to the printing server 2. This report packet is composed of: a reporting device ID, a time slot, a counter counting, and a user counting detail. If an unreported time occurs, the printing server 2 transmits a report request to the MFP 60 via Internet 6.

In this manner, the printing server 2 having received a report packet in which an unreported time slot for one record is filled (there is a possible that a first detailed packet is present) stores the information contained in the report packet in the accounting counter counting table 26c and the user charge detail table 26d, and deletes the unreported time record of the unreported time table 26b.

However, if the print server 2 does not meet all the unreported time slots indicated by the record of the unreported time table 26b, the server stores the once-received report packet in the reserved data in the unreported time record (the reserved data column can store a plurality of report packets).

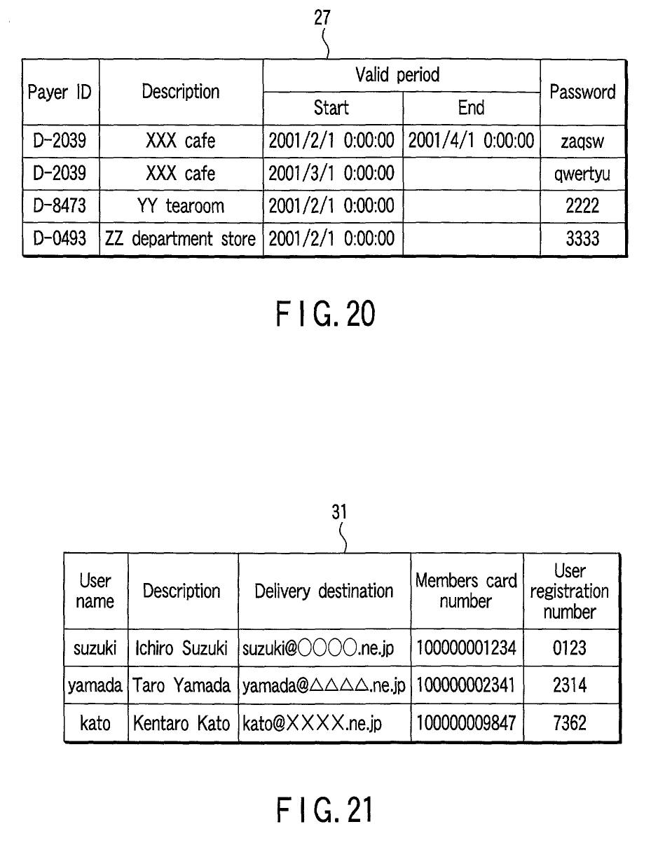

FIG. 20 is a view showing the payer ID management DB 27 stored in the HDD 123 of the print server 2. This payer ID management DB 27 stores the description, the start and end of validity, and password for the payer ID. For example, the description “XX cafe”, the start of validity “2001/2/1 0:00:00” and the end of validity “2001/4/1 0:00:00”, and password “zaqsw” are stored for the payer ID “D-2039”, for example.

In the embodiment, the validity is set for a case where an attempt is made to sometimes change a password. For example, the printing server 2 is rejected if the validity of record with which a password coincides does not contain the current time when printing is executed by the MFP 60.

Now, a database managed by the head shop server 3 will be described here.

FIG. 21 is a view showing an exemplary configuration of a head shop user management DB 31 stored in the HDD 133 of the head shop server 3. This head shop user management DB 31 stores the user name, description, delivery destination, members card number, and user registration number. When the user uses the MFP 64 installed at the shop 5, the user registration number for specifying such a user is stored. For example, for the user name “suzuki”, there are stored: the description “ishiro suzuki”, delivery destination “suzuki@docomo.ne.jp”, members card number “100000001234”, and user registration number “0123”.

This system assumes one printing server and a plurality of head shop servers. Thus, the user management databases are divided respectively.

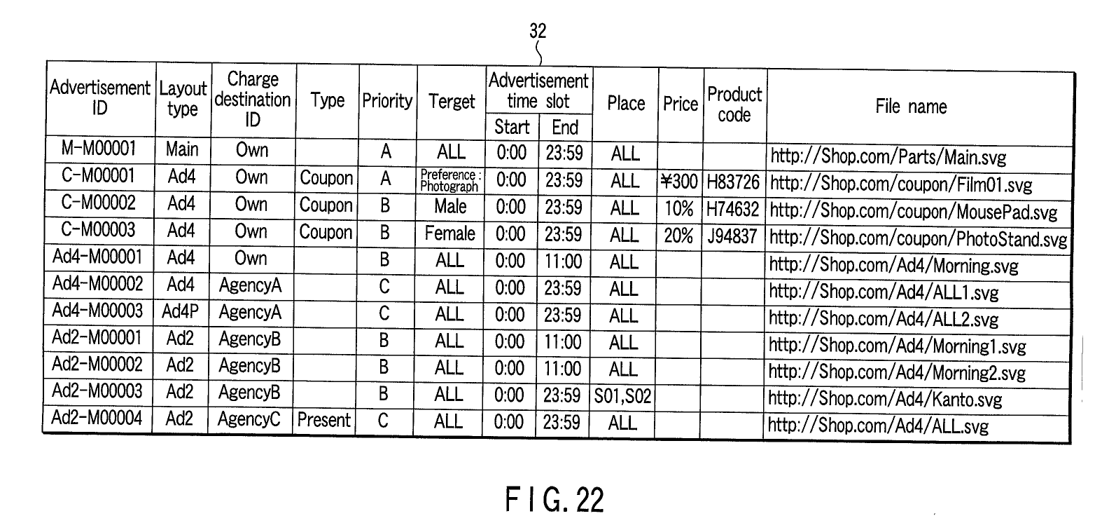

FIG. 22 is a view showing an exemplary configuration of the advertisement DB 32 stored in the HDD 133 of the head shop server 3. This advertisement DB 32 holds a data configuration for managing an advertisement at the head shop. That is, the advertisement DB 32 is composed of: advertisement ID, layout type, charge destination ID, type, priority, target, start and end of advertisement time slot, place, price, product code, and file name. Here, a “place” for specifying a shop that has permitted each advertisement exists, and the shop ID (herein, S01 or S02) can be specified by commas.

For example, for the advertisement ID “Ad2-M00003”, there are stored: layout type “Ad2”, charge destination ID “Agency B”, no type setting, priority “B”, target “ALL”, the start “0:00” and end “23:59” of the advertisement time slot, place “S01, S02”, no price setting, no product code setting, and file name “http://Shop.com/Parts/Ad4/Kanto.svg”.

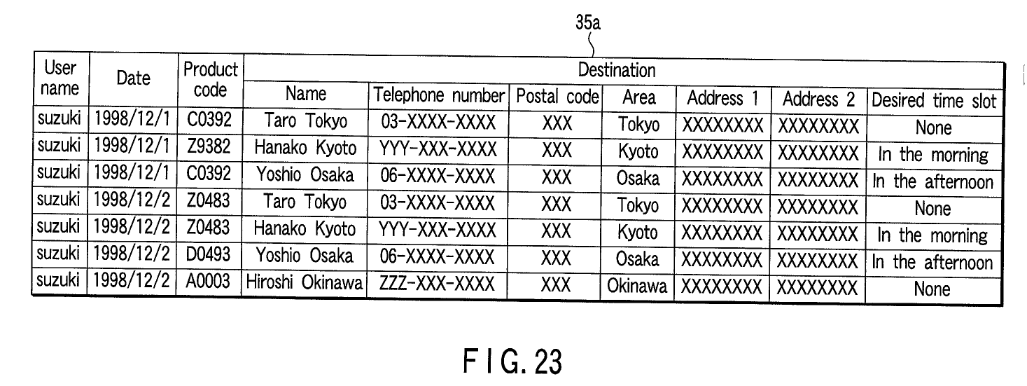

FIG. 23 is a view showing an exemplary configuration of a delivery history table 35a in the delivery destination DB 35 stored in the HDD 133 of the head shop server 3. This delivery history table 35a is composed of: user name; date, product code; name as address destination; telephone number, postal code, area, address 1, address 2, desired time slot or the like. For example, for the user name “suzuki”, there are stored: date “1998/12/1”; product code “CO392”; name as destination “taro tokyo”; telephone number “03-xxxx-xxxx”; postal code “XXX”; area “Tokyo”; address 1 “XXXXXXXX”; address 2 “XXXXXXXX”, and desired time slot “None”.

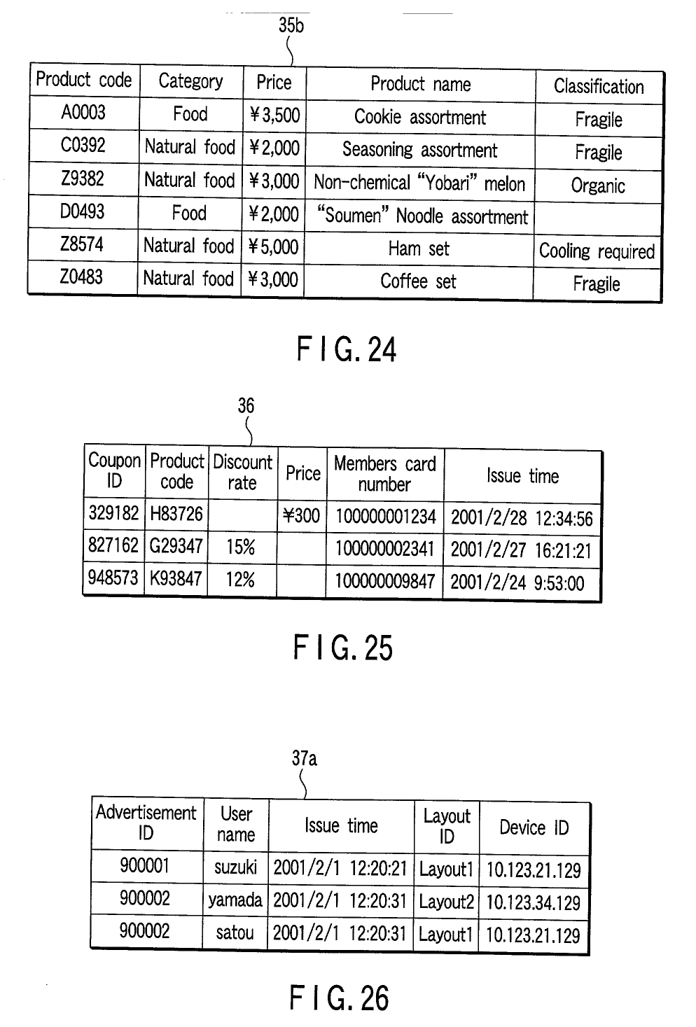

FIG. 24 is a view showing an exemplary configuration of the delivery product master 35b in the delivery destination DB 35 stored in the HDD 133 of the head shop server 3. This delivery product master 35b is composed of produce code, category, price, product name, and classification. For example, the product code “A0003” is stored as category “glossary”, price “3,500 Yen”, product name “cookie assortment”, and classification “fragile”.

FIG. 25 is a view showing an exemplary configuration of the coupon DB 36 stored in the HDD 133 of the head shop server 3. This coupon DB 36 is composed of: coupon ID, product code, discount rate, price, members card number, and issue time. For example, when the coupon ID is 827162, there are stored: product code “G29347”, discount rate “15%”, price “None”, members card number “100000002341”, issue time “2001/2/27/ 16:21:21”.

FIG. 26 is a view showing an exemplary configuration of the advertisement history table 37a in the advertisement history DB 37 stored in the HDD 133 of the head shop server 3. This advertisement history table 37a is provided as a table used for managing the advertisement history such as handbill. That is, this advertisement history table 37a is composed of: advertisement ID assigned to one printed advertisement (handbill); user name, issue time, layout ID, and device ID of the MFP 60 having printed advertisement (handbill). For example, the advertisement ID “900001” is stored as user name “suzuki”, issue time “2001/2/1 12:20:21”, layout ID “Layoutl”, and device ID “10. 123. 21. 129”.

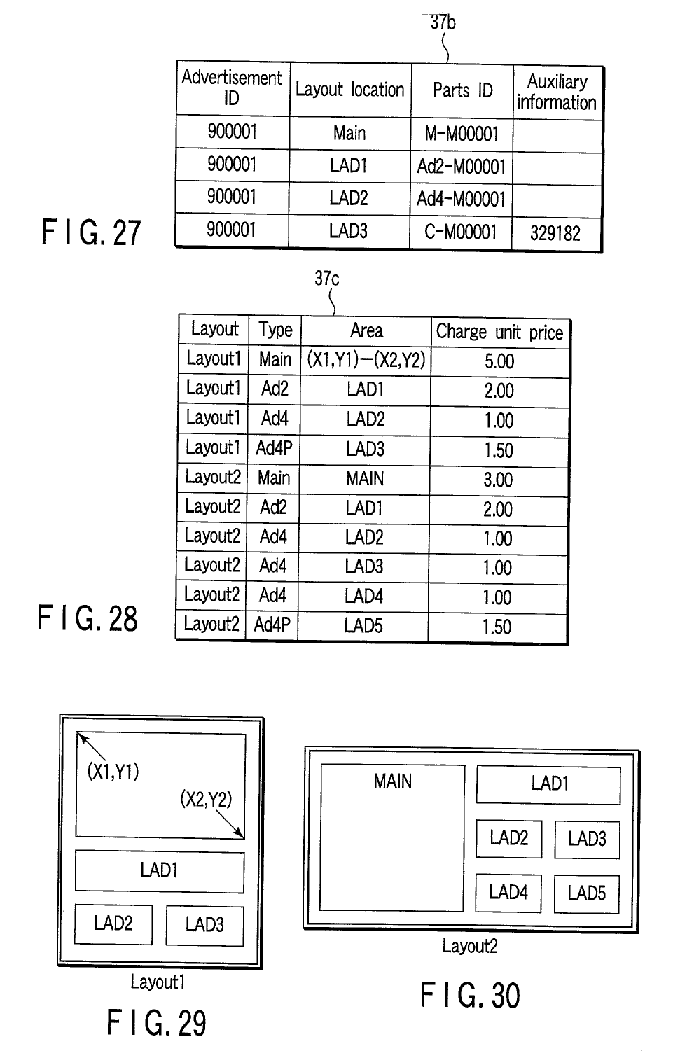

FIG. 27 is a view showing an exemplary configuration of the advertisement parts table 37b in the advertisement history DB 37 stored in the HDD 133 of the head shop server 3. This advertisement parts table 37b stores the layout position, parts ID, and auxiliary information or the like for the advertisement ID with respect to parts printed in one advertisement (handbill). For auxiliary information, the printed coupon ID is stored if parts are coupons. For example, the auxiliary information “329182” is stored in parts ID “C-M00001” of the layout position “LAD3” for the advertisement ID “900001”, for example. This is a coupon ID.

FIG. 28 is a view showing an exemplary configuration of the layout table 37c in the advertisement history DB 37 stored in the HDD 133 of the head shop server 3. This layout table 37c is provided as a table used to set a layout of an advertisement (handbill) document to be printed. That is, the layout table 37c is composed of Layout, Type, Area, and charge unit or the like.

In the present embodiment, two layouts Layout1 and Layout2 can be specified as a layout configuration of an advertisement document.

FIG. 29 shows a configuration of Layout1. That is, Layout 1 uses paper longitudinally, wherein an upper half of paper is defined as a large parts layout area (Main), and a lower half of paper is defined as a small parts layout area. The lower half is further divided vertically, and the upper half is defined as a layout area (LAD1) of a transversely elongated layout area. The lower side is further divided transversely, and is defined as layout areas (LAD2, LAD3) of the respective small parts.

FIG. 30 shows a configuration of Layout2. That is, Layout2 uses paper transversely, wherein the left half of paper is defined as large parts layout area (Main), and the right hand is defined as a small parts layout area. The right half is further divided vertically into three sections, and the upper 1/3 is defined as a long parts layout area (ADl). The middle 1/3 and lower 1/3 each are further divided transversely, and are defined as the respective small parts layout areas (LAD2, LAD3, LAD4, LAD5).

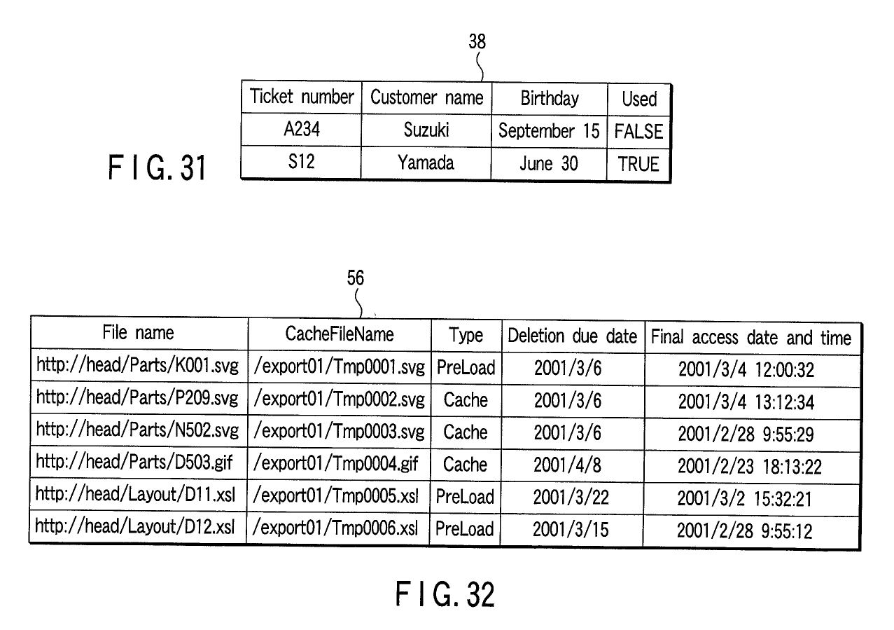

FIG. 31 is a view showing an exemplary configuration of the ticket DB 38 stored in the HDD 133 of the head shop server 3. This ticket DB 38 is provided as a database when this system is used for tickets. Although described later in detail, the ticket DB 38 is composed of ticket number, customer name, birthday, and completed use.

FIG. 32 is a view showing an exemplary configuration of the cache preceding transmission buffer 56 stored in the HDD 55a of the printing shop server 55 in the shop 5. This cache preceding transmission buffer 56 stores parts configuring part of a print image as a cache memory. That is, this cache preceding transmission buffer 56 stores an ID (URL or the like is available) assigned by being stored in a file for parts, a cache file name being stored, type, deletion due date, and final access date and time. For example, for file name “http://head/Parts/K001.svg”, there are stored: cache file name “/export01/Tmp0001.svg”, type “PreLoad”, deletion due date “2001/3/6”, and final access date and time “2001/3/4 12:00:32”.

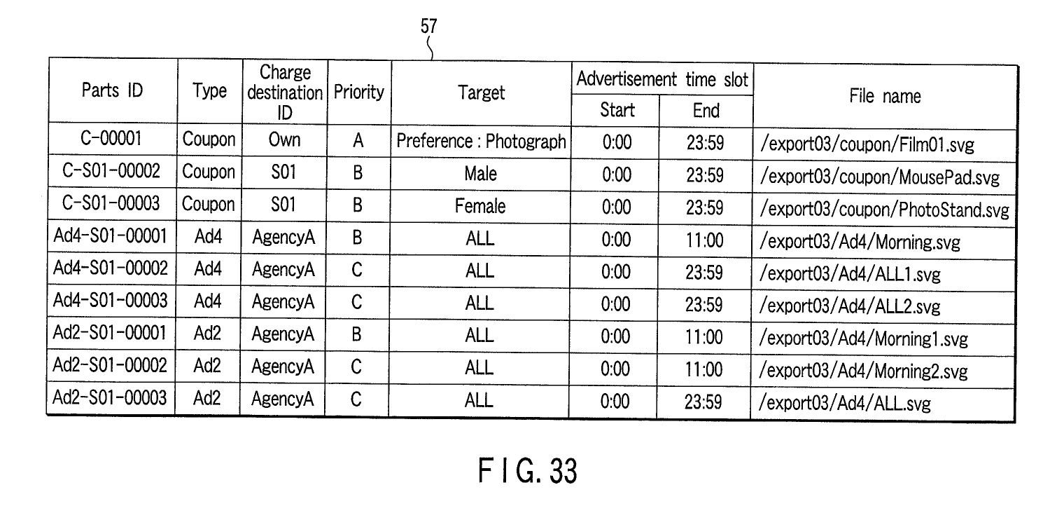

FIG. 33 is a view showing an exemplary configuration of the shop internal advertisement DB 57 stored in the HDD 55a of the printing shop server 55. This shop internal advertisement DB 57 is provided as a database required for preparing an advertisement at the shop 5, and one item of advertisement data is stored for one record. That is, for parts ID, this shop internal advertisement DB 57 stores: type of which an attribute of advertisement data is laid out in advertisement; charge destination ID; priority when a plurality of advertisement data can be printed; target of this advertisement; start and end of permissible time slot for advertisement; and file name.

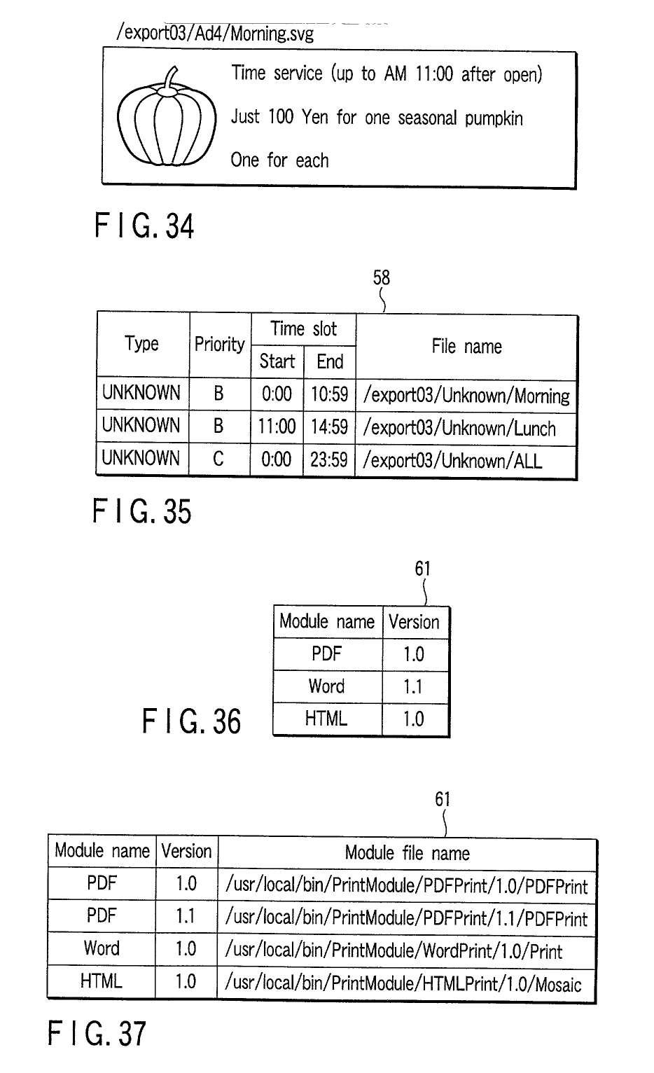

FIG. 34 is an example of advertisement data prepared at the shop 5. Advertisement data includes image data allocated in advance such as product image photograph, price, and catch copy. These items may be managed completely independently.

FIG. 35 is a view showing an exemplary configuration of the unregistered person oriented advertisement DB 58 stored in the HDD 55a of the printing shop server 55 at the shop 5. First, if a customer is an unregistered person, the customer's profile is unknown. Thus, what kind of advertisement should be presented is unknown. Therefore, some advertisements are prepared for this unregistered person oriented advertisement DB 58, and can be switched for each time slot. This unregistered person oriented advertisement DB 58 is composed of: type; priority; start and end of time slot, and file name. For example, as one of types “UNKNOWN” indicating an unregistered person, there is stored: priority “B”, the start of time slot “0:00”; the end of time slot “10:59”, and file name “/export03/Unknown/Morning”.

FIG. 36 is a view showing an exemplary configuration of the printing module management DB 61 stored in the memory 142 of the MFP 60. This printing module management DB 61 is composed of a module name and a version, and the version is managed as one record for each module installed in the MFP 60 (only one version can be installed for each module). For example, the module name is “PDF”, and the version is “1.0”.

FIG. 37 is a view showing another exemplary configuration of the printing module management DB stored in the memory 142 of the MFP 60. This printing module management DB 61 is composed of a module name, a version, and a module file name of module of such version, and the version is managed as one record for each module installed in the MFP 60.

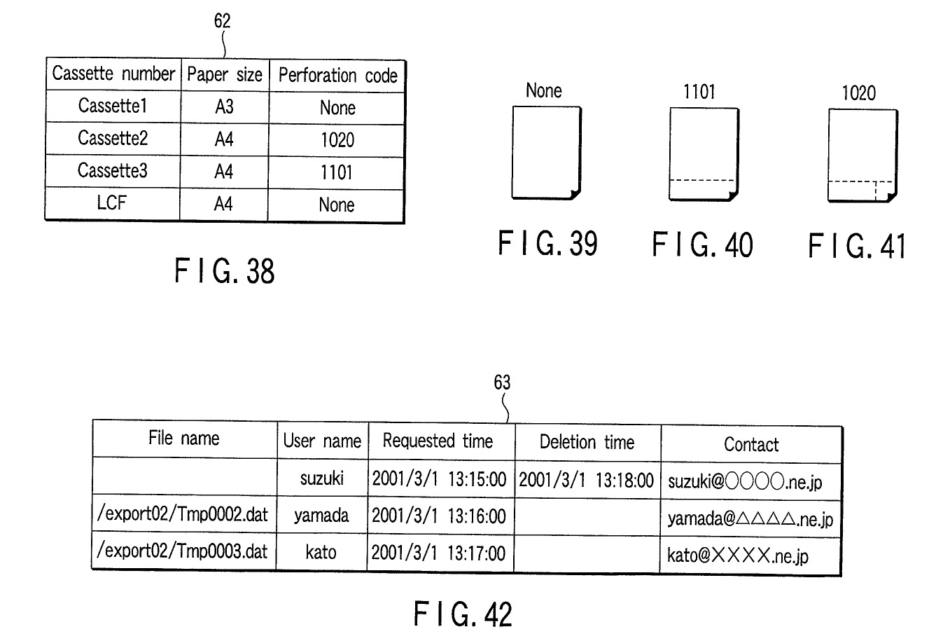

FIG. 38 is a view showing an exemplary configuration of the cassette information DB 62 stored in the memory 142 of the MFP 60. Here, the MFP 60 has cassettes for setting four papers such as Cassette1, Cassette2, Cassette3, and LCF. Then, this cassette information DB 62 stores information on what kind of perforated paper is set in a respective one of these cassettes. This cassette information DB 62 is composed of cassette number, paper size, and perforation code.

In perforation, if no perforation as shown in FIG. 39 is provided, a perforation code is defined as “None”. If perforation is provided transversely in the lower section as shown in FIG. 40, a perforation code is defined as “1101”. If perforation is provided longitudinally and transversely in the lower section as shown in FIG. 41, a perforation code is defined as “1020”. For example, for cassette number “cassette2”, a paper size is defined as “A4”, and a perforation code is defined as “1020”.

FIG. 42 is a view showing an exemplary configuration of the temporary storage buffer 63 stored in the memory 142 of the MFP 60. This temporary storage buffer 63 stores a file name, a user name, a requested time, a deletion time, and a contact or the like. For example, for the file name “/export02/Tmp0002.dat”, there are temporarily stored: user name “yamada”, requested time “2001/3/1 13:16:00”, and contact “yamada@ezweb.ne.jp”, but no deletion time is stored.

Now, an operation in such a configuration will be described.

The entire flow of operation in this advertisement transmitting system is greatly divided into two sections below. One section is from the user operating the portable telephone set 1 to registering an advertisement document (handbill) in the printing server 2. The other section is from acquiring a registered document from the MFP 60 to printing the document.

First, an operation for registering an advertisement document in the printing server 2 will be described in three patterns.

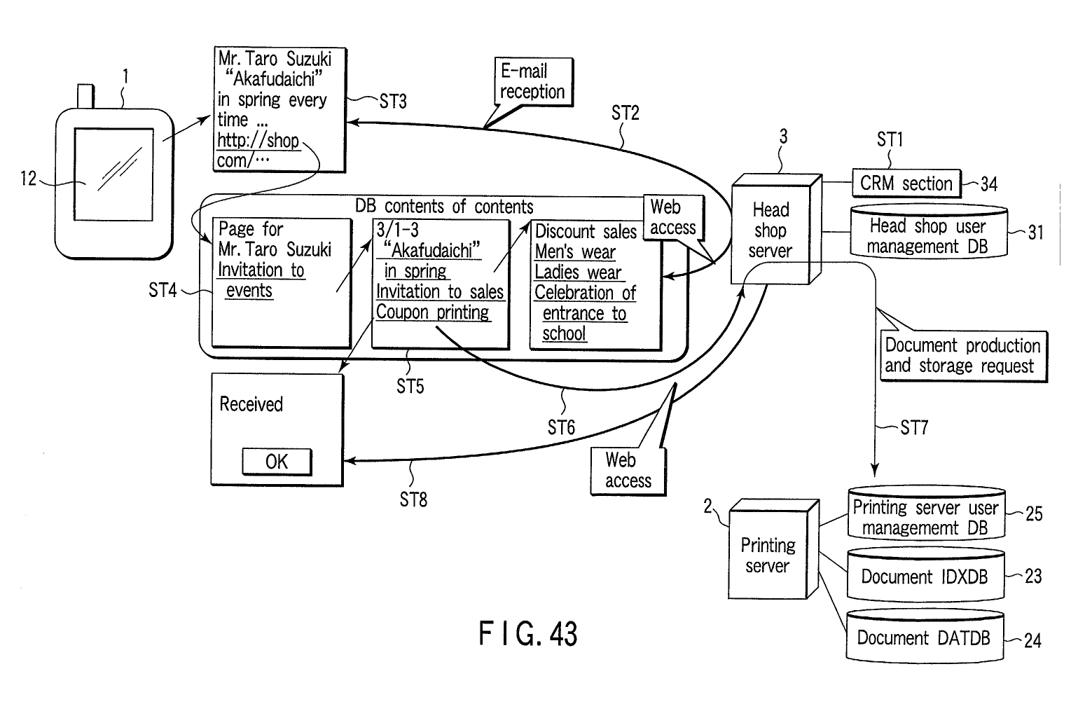

A first operation for registering the advertisement document in the printing server 2 will be described as an operation for registering a print document with reference to FIG. 43.

First, at the head shop server 3, the CRM section 34 determines in advance a user who transmits an advertisement such as direct mail and the contents of advertisement (advertisement document) (ST1).

The controller 131 of the head shop server 3 searches the head shop user management DB 31 for the user determined at the CRM section 34; specifies an E-mail address of a delivery destination from a user name; and transmits the advertisement document determined at the CRM section 34 to the portable telephone set 1 of the user via Internet 6 (ST2).

The advertisement document is displayed at the display section 12 of the portable telephone set 1 by the user's E-mail receiving operation (ST3). A link oriented to the user for shop is inserted in this advertisement document. For example, http://Shop.com/CRM/Event1024/Index.cgi?UserID=Suzuki&p wd=password” or the like is inserted.

When the user clicks this link from the operating section 13 of the portable telephone set 1, the control section 11 reads out the contents stored in advance in the contents DB 33 of the head shop server 3 via Internet 6, and displays them at the display section 12 (ST4).

When the user further clicks a link on the contents displayed at the display section 12 from the operating section 13, the control section 11 reads out the contents of the link stored in the contents DB 33 of the head shop server 3 via Internet 6, and displays them at the display section 12. In addition, this contents of the link include a link for printing a coupon (ST5).

When the user clicks the link for printing the coupon displayed at the display section 12 from the operating section 13, the control section 11 transmits a URL that contains the user information to the head shop server 3 via Internet 6 (ST6).

The controller 131 of the head shop server 3 having received the URL that contains the user information creates an advertisement document according to an event or user from the information contained in URL, and transmits a request for storing the advertisement document data to the printing server 2 (ST7).

The controller 121 of the printing server 2 stores (registers) the advertisement document data in the document IDXDB (registering section) 23 and document DATDB (registering section) 24 according to a storage request from the head shop server 3, and returns the result to the head shop server 3. When the storage result from the printing server 2 is returned, the controller 131 of the head shop server 3 transmits the receipt of the coupon print to the portable telephone set 1 via Internet 6 (ST8). The control section 11 of the portable telephone set 1 having received acceptance information displays the coupon print from the head shop server 3 at the display section 12.

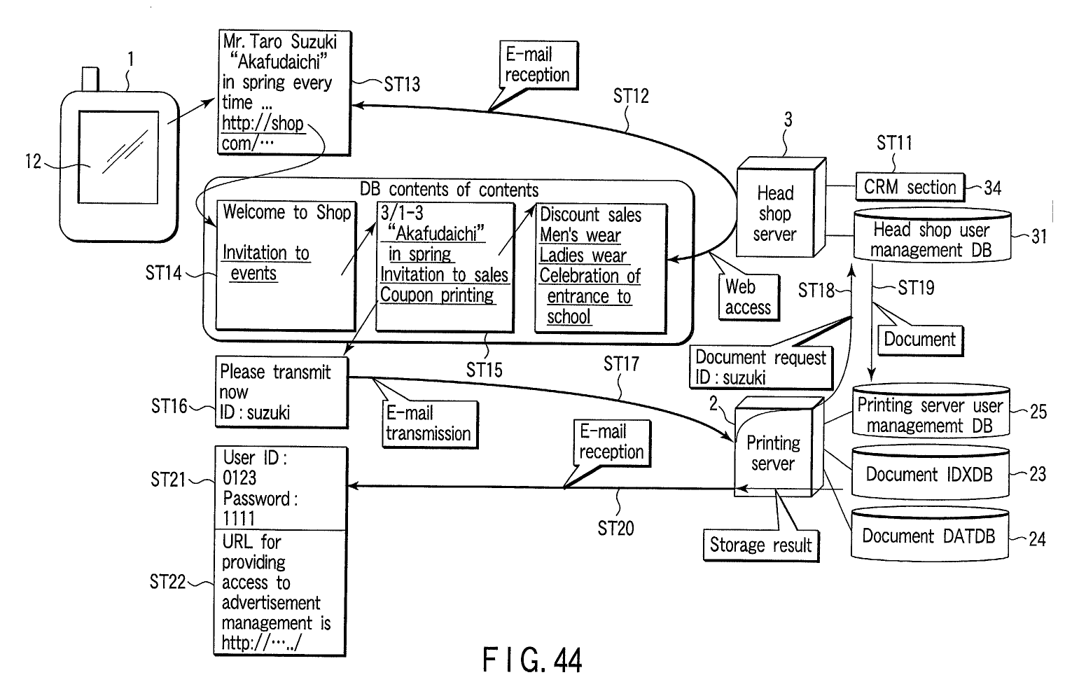

Now, a second operation for registering an advertisement document in the printing server 2 will be described as an operation for registering an print document with reference to the flow chart of FIG. 44.

At the head shop server 3, the CRM section 34 determines in advance the user who transmits an advertisement such as direct mail and the contents of advertisement (advertisement document) (ST11).

The controller 131 of the head shop server 3 searches the head shop user management DB 31 for the user determined at the CRM section 34; specifies an E-mail address of a delivery destination from a user name; and transmits the advertisement document determined at the CRM section 34 to the portable telephone set 1 of the user via Internet 6 (ST12).

The advertisement document is displayed at the display section 12 of the portable telephone set 1 by the user's mail receiving operation (ST13). A link oriented to the user for shop is inserted in this advertisement document. For example, “http://Shop.com/” or the like is inserted.

When the use clicks this link from the operating section 13 of the portable telephone set 1 or inputs URL, the control section 11 reads out the contents of a homepage of shop stored in the contents DB 33 of the head shop server 3 via Internet 6, and displays them at the display section 12 (ST14).

When the user further clicks a link on the contents displayed at the display section 12 from the operating section 13, the control section 11 reads out the contents of the link stored in advance in the contents DB 33 of the head shop server 3 via Internet 6, and displays then at the display section 12. In addition, the link contents include a link for printing a coupon (ST15). A link for transmitting a mail to the printing server 2 is provided for this coupon printing. For example, <A HREF=“mailto: shop@print,com?body=Please transmit. ID:shop,suzuki”>coupon print</A> or the like is inserted.

When the user clicks this link displayed at the display section 12 from the operating section 13, the control section 11 initiates E-mail software (ST16). Then, the control section 11 transmits an E-mail to the printing server 2 in accordance with this message (ST17)

At the printing server 2 having received this E-mail, the controller 121 specifies the head shop server and user in accordance with a character string following “ID:”, and requests a document to the head shop server 3 (ST18).

At the head shop server 3 having received this document request, the controller 131 produces document data oriented to a user requested by using the CRM section 34, and returns the data to the printing server 2 (ST19).

At the printing server 2 having received this returned document data, the controller 121 stores this document data in the document IDXDB 23, document DATDB 24, and printing server user management DB 25, and transmits the result as an E-mail to the portable telephone set 1 (ST20).

At this time, the user ID and password (ST21) and a link of this user's advertisement management page are provided at an E-mail that the user receives (ST22).

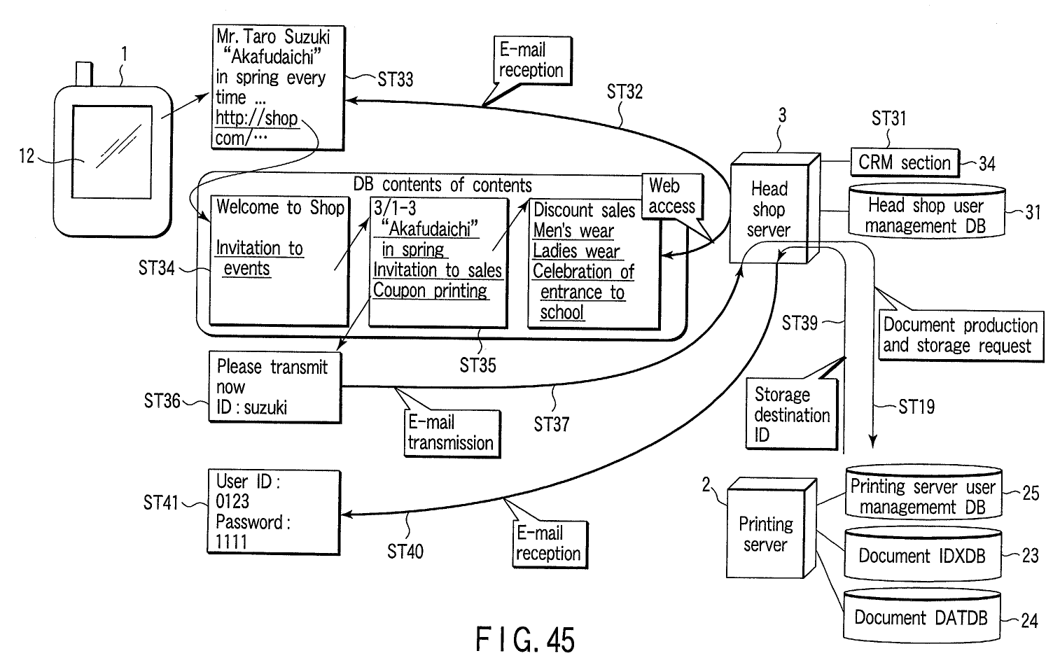

Now, a third operation for registering an advertisement document in the printing server 2 will be described as an operation for registering a print document with reference to the flow chart of FIG. 45. Here, a target of receiving an E-mail for storing a print document from a user is not the printing server 2, but the head shop server 3.

First, at the head shop server 3, the CRM section 34 determined in advance the user who transmits an advertisement such as direct mail and the contents of advertisement (advertisement document) (ST31).

The controller 131 of the head shop server 3 searches the head shop user management DB 31 for the user determined at the CRM section 34; specifies the E-mail address of a delivery destination from a user name; and transmits the advertisement document determined at the CRM section 34 to the portable telephone set 1 of the user via Internet 6 (ST32).

The advertisement document is displayed at the display section 12 of the portable telephone set 1 by the user's Email receiving operation (ST33). A link oriented to the user for shop is inserted in this advertisement document. For example, “http://Shop.com/” or the like is inserted.

When the user clicks this link from the operating section 13 of the portable telephone set 1 or inputs URL, the control section 11 reads out the contents of a homepage of shop stored in the contents DB 33 of the head shop server 3 via Internet 6, and displays them at the display section 12 (ST34).

When the user further clicks a link on the contents displayed at the display section 12 from the operating section 13, the control section 11 reads out the contents of the link stored in advance in the contents DB 33 of the head shop server 3 via Internet 6, and displays them at the display section 12. In addition, the contents of the link include a link for printing a coupon (ST35). A link for transmitting an E-mail to the printing server 2 is provided for this coupon printing. For example, <A HREF=“mailto:shop@print.com?body=please transmit. ID: shop, suzuki”> coupon printing</A> or the like is inserted.

When the user clicks this link displayed at the display section 12 from the operating section 13, the control section 11 initiates E-mail software (ST36). Then, the control section 11 transmits an E-mail to the head shop server 3 in accordance with this message (ST37)

At the head shop server 3 having received this E-mail, the controller 131 specifies a user from the delivered user's mail address; produces document data oriented to user requested by using the CRM section 34; and instructs transmitting “store” to the printing server 2 (ST 38).

At the printing server 2 having received this transmitted document data, the controller 121 stores this document data in the document IDXDB 23, document DATDB 24, printing server user management DB 25, and transmits the user ID to the head shop server 3 (ST39).

At the head shop server 3 to which this user ID has been returned, the controller 131 notifies this user ID to the user via E-mail (registration completion mail) (ST40). If the user ID is not newly registered, the user ID may not be notified in particular. At this time, the user-receiving E-mail includes the user ID and password (ST41). A link with the user's advertisement management page may be provided.

Now, a printing method will be described here.

An operation for printing a document registered as described above will be described in three patterns.

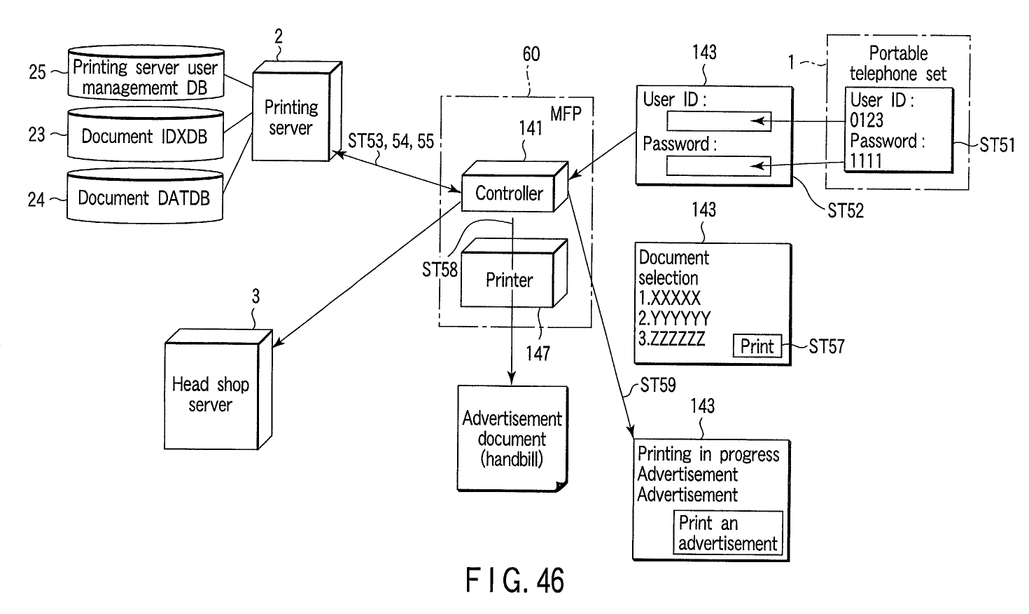

First, an operation for instructing printing in accordance with an operation from a touch panel 143a of a display section 143 provided at the MFP 60 will be described with reference to the flow chart of FIG. 46.

At the shop 5 at which the MFP 60 is installed, the user checks the user ID and password via the registration completion mail previously delivered to the portable telephone set 1 (ST51).

The user inputs the checked user ID and password from the touch panel 143a of the display section 143 of the MFP 60 (ST52). The input screen at the display section 143 can be displayed by making a selection from a menu screen (not shown).

The controller 141 of the MFP 60 inquires the inputted user ID and password to the printing server 2 via Internet 6 (ST53).

The controller 131 of the printing server 2 checks the inquired user ID and password by referring to the printing server user management DB 25. If they are incorrect, an error is returned, and the fact is notified to the portable telephone set 1 via Internet 6 (ST54).

In addition, when the user ID and password are correct, the controller 121 transmits a list of advertisement documents or the like of the user to the MFP 60 via Internet 6 by referring to the document IDXDB 23 (ST55).

The controller 141 of the MFP 60 displays a list of the received advertisement documents as “selected documents” at the display section 143 (ST56).

Here, the user selects a desired print advertisement document, and presses a print button displayed at the display section 143 (or inputs the button from the touch panel 143a) (ST57).

The controller 141 of the MFP 60 acquires a selected document from the document DAT 24 of the printing server 2 via Internet 6, and prints the document by a printer 147 (ST58).

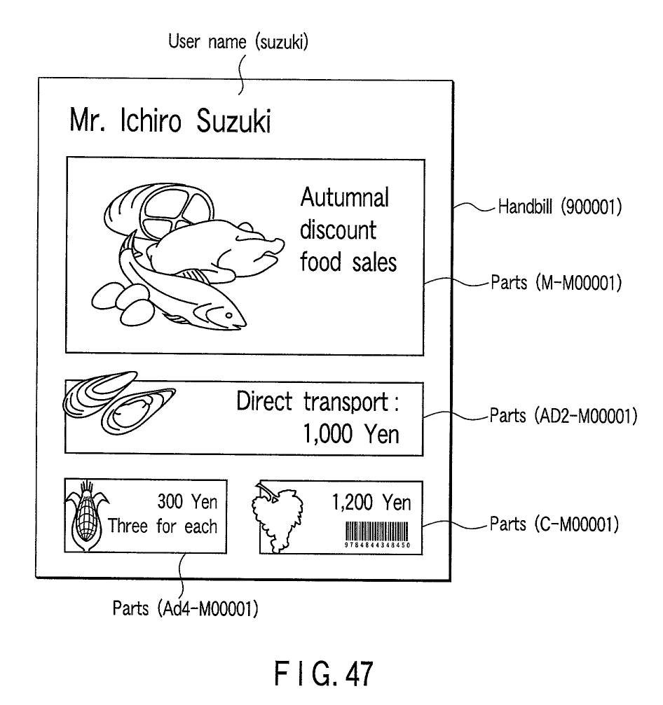

FIG. 47 shows an example of an advertisement document printed by the printer 147. During this printing, the controller 141 displays “printing in progress” at the display section 143, and displays “an advertisement”. When a display key “print an advertisement” is pressed, the advertisement is further printed (ST 59).

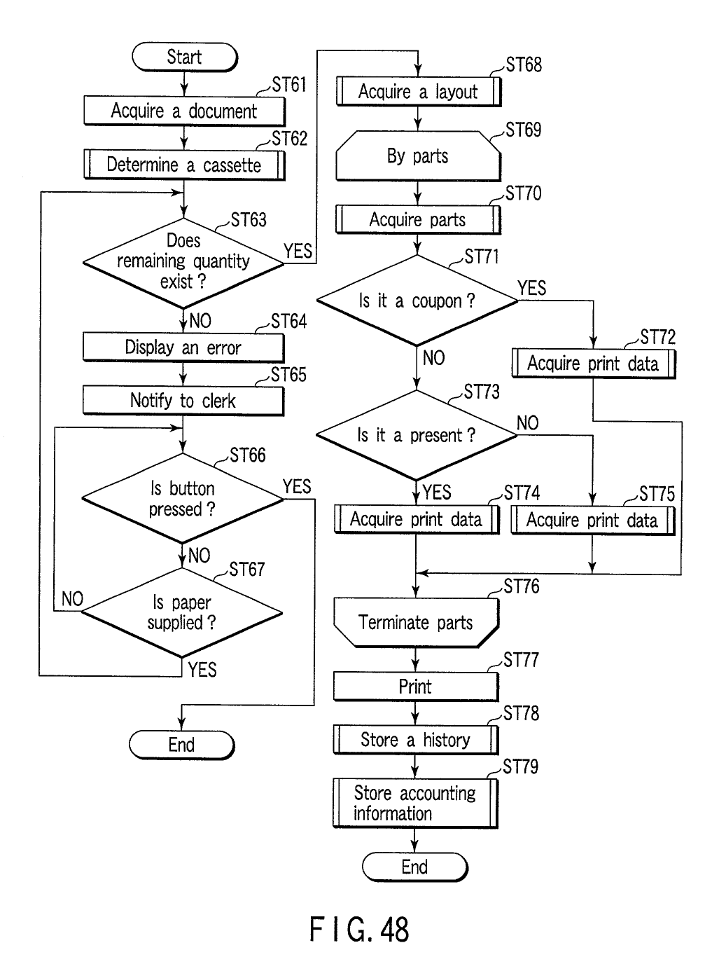

Now, a printing operation at the step ST58 will be described in detail with reference to the flow chart of FIG. 48.

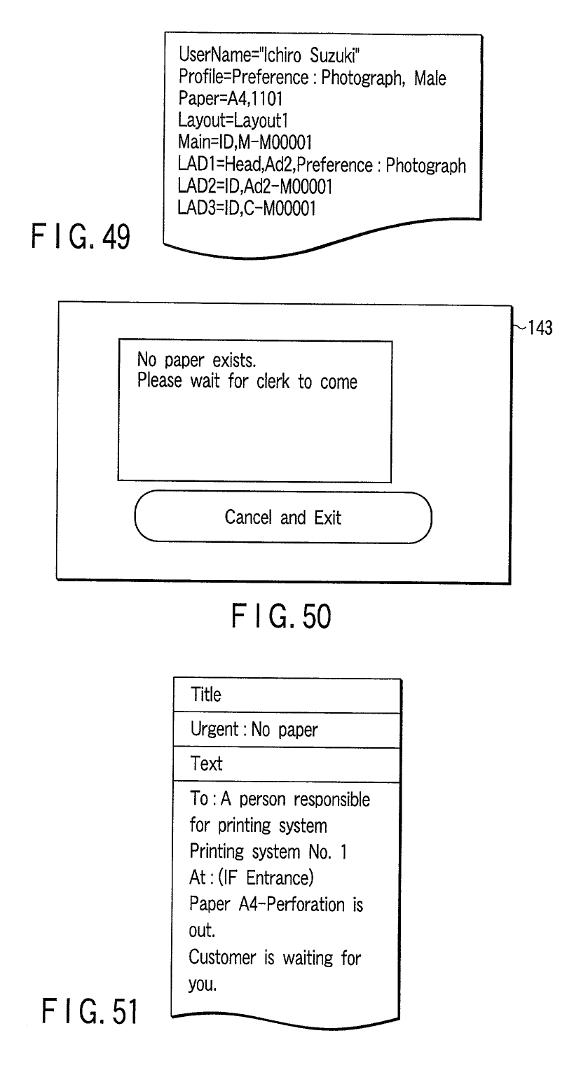

The controller 141 of the MFP 60 acquires an advertisement document (ST61). FIG. 49 shows an example of the acquired advertisement document.

The controller 141 determines a cassette in which paper used for printing from the acquired advertisement document is stored (ST62). In an example of FIG. 49, this cassette is determined by “Paper=A4, 1101”.

Here, the controller 141 checks the remaining quantity of paper (ST63). If paper is insufficient in quantity, an error is displayed at the display section 143 (ST64).

FIG. 50 shows an error display example of the display section 143. A message “No paper. Wait for clerk to come.” is displayed. A button “Cancel and Exit” is displayed so as to accept a cancellation instruction (touch panel 143a) from a user who cannot wait until paper has been supplied.

Further, the controller 141 notifies no paper to the portable telephone set 1 owned by a clerk (not shown) (clerk at the shop 5) (ST65).

FIG. 51 is an example when notification “no paper” is transmitted to the portable telephone set 1 of clerk.

Here, paper is supplied by the clerk. When the button “Cancel and Exit” is pressed, the controller 141 terminates displaying and printing an advertisement document (ST66).

After paper has been supplied or if the paper still remains at the step ST63, the controller 141 acquires a layout from the acquired advertisement document (ST68). In the example of FIG. 49, this layout is acquired by “Layout=Layout1”.

Then, the controller 141 acquires document data by parts of the advertisement document (ST69 to ST76).

First, the controller 141 checks whether or not a coupon is present (ST71). If the coupon is present, coupon print data is acquired (ST72). In addition, the controller checks whether or not a gift is present (ST73). If the gift is present, gift print data is acquired (ST74). Then, if parts other than these elements are present, the print data is acquired (ST75).

The controller 141 having acquired print data on parts forming an advertisement document is configure in the above acquired layout, and the data is printed by the printer 147 (ST77).

When printing has completed, the controller 141 transmits this print history to the head shop server 3 via Internet 6. The controller 131 of the head shop server 3 stores the received print history in the advertisement history table 37a of the advertisement history DB 37 (ST78).

Further, the controller 141 transmits accounting information to the printing server 2 via Internet 6. The controller 121 of the printing server 2 stores the received accounting information in the accounting DB 26 (ST79).

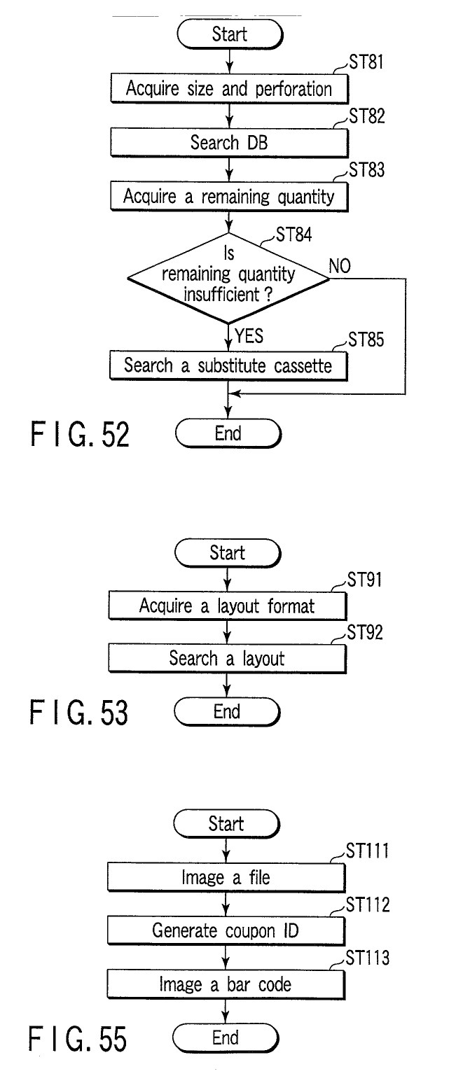

Now, an operation for determining a cassette at the step ST 62 will be described in detail with reference to the flow chart of FIG. 52.

The controller 141 of the MFP 60 acquires paper size and perforation code from “paper” in the acquired advertisement document (ST81). In an example of FIG. 49, “paper=A4, 1101” is set, and the paper size “A4” and perforation code “1101” can be acquired.

The controller 141 searches a cassette having the corresponding size and perforation code based on the cassette information DB 62. In the cassette information DB 62 shown in FIG. 38, a search is made by the size “A4” and perforation code “1101”, and “Cassette 3” is searched (ST82).

Here, the controller 141 inquires the printer 147 as to whether or not paper is full in the cassette (ST84). When the paper is sufficient in quantity, processing terminates. If the paper is insufficient in quantity, the controller 141 searches the cassette information DB 62 while the perforation code is substituted by “None (No perforation)” shown in FIG. 39. At the size “A4” and perforation code “None”, the cassette number “LCF” is searched. The controller 141 supplies paper while this being a substitute cassette. As described at the step ST63 to ST67, it is possible for the user to wait until clerk supplies paper.

Now, an operation for acquiring a layout at the step ST68 will be described in detail with reference to the flow chart of FIG. 53.

The controller 141 of the MFP 60 acquires a layout format from “Layout” contained in the acquired advertisement document (ST91). In an example shown in FIG. 49, “Layout1” can be acquired.

The controller 141 searches a layout table 37c shown in FIG. 28 by using this acquired layout format (ST92). In this way, the controller 141 acquires a list of parts areas to be printed. The parts area acquires “Type”. In the layout table 37c shown in FIG. 28, when a search is made by the layout format “Layout1”, “Main”, “Ad2”, “Ad4”, and “Ad4P” can be acquired as “Type”. Similarly, “Area” and a charge unit price can be acquired as well.

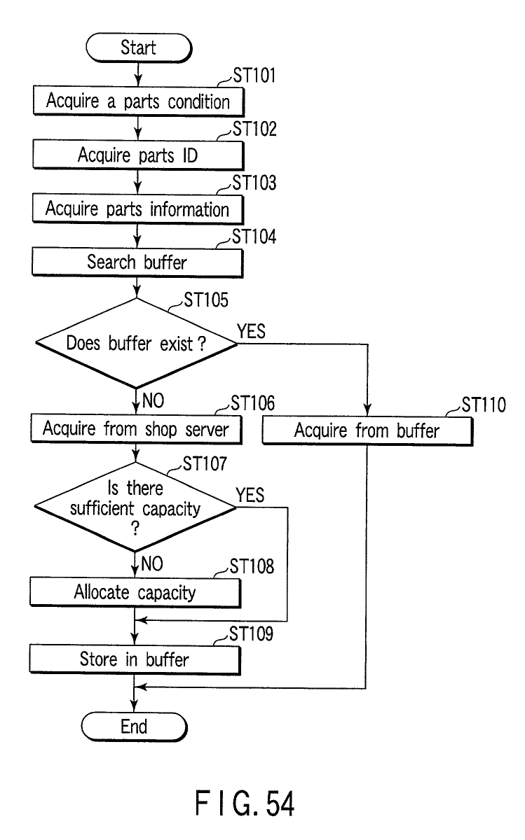

Now, an operation for acquiring parts at the steps ST69 to 76 will be described with reference to the flow chart of FIG. 54.

The controller 141 acquires parts conditions to be printed in the parts area stored in a document from “Type” of the parts area to be printed, the area being acquired by layout acquisition (ST101). For example, “Type” at line 1 of “Layout1” in the layout table 37c shown in FIG. 28 is obtained as “Main”. Parts condition “ID,M-M00001” can be acquired from “Main” in the document shown in FIG. 49.

The controller 141 acquires parts ID in accordance with the acquired parts condition (ST102). For example, when a first element is “ID”, a second element is obtained as parts ID or the like. In “ID,M-M00001”, “M-M00001” is obtained as parts ID.

The controller 141 searches an advertisement DB 32 from this parts ID via the shop internal advertisement DB 57 or Internet 6, and acquires parts information (ST103). From these elements, a parts file name is acquired. For example, in the advertisement DB 32 as shown in FIG. 22, a search is made by “M-M00001”, whereby “Main”, “Own”, “NULL”, and “http://Shop.com/Parts/Main.svg” can be acquired as “LayoutType”, “charge destination ID”, “Type”, and a file name, respectively.

Then, the controller 141 searches a cache preceding transmission buffer 56 in order to acquire a file entity from a file name (ST104). When the above file name exists, the file name is acquired (ST105 and ST110).

In the cache preceding transmission buffer 56 shown in FIG. 32, a record having its file name “http://Shop.com/Parts/Main.svg” is not found. If the above file name is not found at the step ST105, the controller 141 makes inquiry to the head shop server 3 based on the file name, and acquires the file entity (ST106).

Here, the controller 141 checks the residual capacity of the cache preceding transmission buffer 56 (ST107). If the residual capacity is insufficient, a deletion candidate is selected, and the capacity is allocated (ST108). In the cache preceding transmission buffer 56, data in which “Type” is obtained as “Cache” is deleted in order from the oldest one in terms of the final access dates and times, and a sufficient capacity is allocated.

Then, where the sufficient capacity is allocated at the step ST108 or where the sufficient capacity is present at the step ST107, the controller 141 registers (stores) the file entity and information in the cache preceding transmission buffer 56 (ST109).

In the cache preceding transmission buffer 56, “CacheFileName” is defined as an ID (for example, file name) when the entity is stored in the file storage region in the buffer, and “Type” is defined as “Cache”. The deletion due date is defined as a value obtained when a time defined in advance for the controller 141 is added to the current time, and the final access date and time are defined as the current time. When the file entity is acquired from the cache preceding transmission buffer 56, the final access date and time are rewritten into the current time.

In addition, for example, in FIG. 49, the parts condition for parts area “LAD1” is defined as “Head,Ad2, Preference: Photograph”. This denotes the following.

The first element indicates where a privilege to issue parts to this area is. Namely, this indicates whether the MFP 60 has installed at “Shop”, “Head”, or “specific shop” (for example, S01 is defined as shop ID).

The second element indicates layout type of this area. Namely, this indicates the size or shape of a region in which parts are allocated. Here, “Ad2” is defined, which indicates an elongated area.

The third element indicates preference of this customer. Here, “Preference: Photograph” is defined.

In addition, where the first element of the parts condition is defined as “Head”, the above step ST102 makes inquiry to the CRM section 34 of the head shop server 3. The CRM section 34 returns the parts ID that exists in the advertisement DB 32 after checking the above inquiry.

In addition, where the first element of the parts condition is defined as “Shop”, the above step ST102 searches parts from the shop internal advertisement DB 57. In the second element as well, it is checked that all elements are present in an inventory management system and a search is made for parts having “Target” that coincides with “Profile” of the customer existing in the document in FIG. 49.

Further, where a search is made by the above first element, the contents of print can be determined depending on a printing time by considering an advertisement time of the advertisement DB 32 or shop internal advertisement DB 57.

A shop ID for advertising the parts is considered in a location column of the shop internal advertisement DB 57, whereby the contents of print can be determined depending on the printing time. For example, parts ID “Ad2-M00003” of the shop internal advertisement DB 57 has “S01” and “S02” as a location, and the shop ID can be printed only at the shop “S01” or “S02”.

Now, a coupon printing operation will be described with reference to the flow chart of FIG. 55.

The controller 141 of the MFP 60 having acquired parts of a coupon at the step ST72 prints an acquired file in the layout area (LAD1) of the parts (ST111). The controller 141 stores parts data (product code, discount rate, price), members card number of operating user, and the current time as issue time in the coupon DB 36. At this time, a coupon ID is newly generated (ST112). The controller 141 prints the generated coupon ID as a bar code in an assigned information printing area in a layout area (ST113).

Now, a description of gift printing will be given here.

The controller 141 having acquired parts of a gift prints an acquired file in the layout area (LAD1) of the parts. The controller 141 searches a delivery history table 35a; acquires the past-delivered history, and prints information acquired in the assigned information printing area in the layout area. In the acquired history cannot be printed in the area, a delivery product master 35b is searched. Then, products of parts are displayed preferably in order from those in the same amount and category.

Now, a description of storing history information will be given here.

The controller 141 generates a unique advertisement ID that is not present in the advertisement history table 37a. Then, the controller 141 carries out control for registering the advertisement ID, user name (operating user name), issue time (current time), layout ID (parts layout ID), and device ID as a record. Further, the controller 141 carries out control for recording information concerning parts printed in the advertisement parts table 37b.

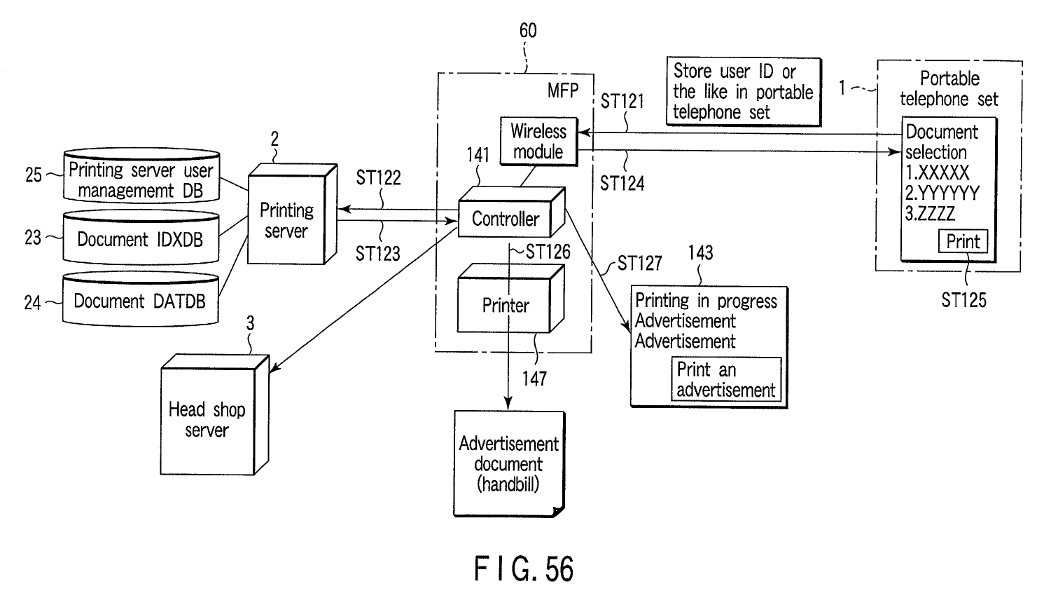

Now, a printing operation made by providing access to the MFP 60 using weak radio from the portable telephone set 1 (with a local wireless access function) will be described with reference to the flow chart of FIG. 56.

A user provides access to the MFP 60 by using a local wireless access function (such as Bluetooth) of the portable telephone set 1. At this time, the user ID registered in the portable telephone set 1 is transmitted (ST121).

The controller 141 of the MFP 60 provides access to the printing server 2 via Internet 6 by using the received user ID (ST122).

If a user is registered from the user ID (user name) received by referring to the printing server user management DB 25, the controller 121 of the printing server 2 produces a list of documents by referring to the document IDXDB 23, and returns the list to the controller 141 of the MFP 60 (ST123).

The controller 141 of the MFP 60 returns the returned list of documents to the portable telephone set 1 (ST124).

Here, the user selects a desired print document from the documents displayed at the portable telephone set 1, and requests printing by the print button (ST125).

The controller 141 of the MFP 60 acquires the document data requested for printing from the portable telephone set 1 from the document DATDB 24 of the printing server 2 via Internet, and prints the advertisement document by using a printer 147 (ST126). The controller 141 displays “printing in progress” at the display section 143, as shown in FIG. 56 during printing, and acquires advertisement information from the shop internal advertisement DB 57 or the like to display “advertisement” (ST127). At this time, the advertisement can be printed by the button “print an advertisement”.

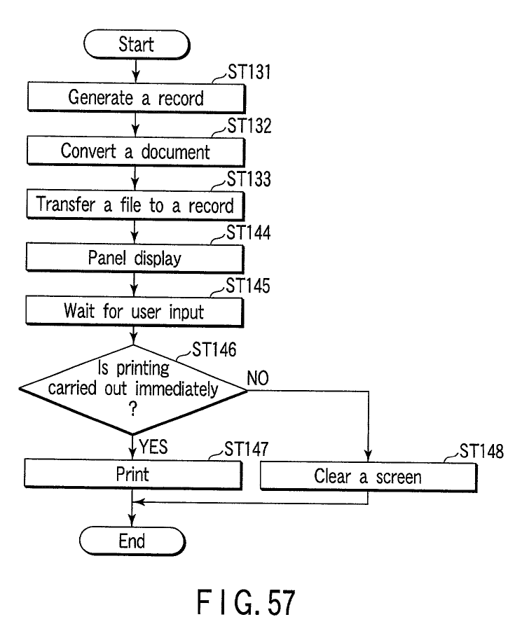

Now, another embodiment of printing an advertisement document at the above step ST126 will be described with reference to the flow chart of FIG. 57.

When the controller 141 of the MFP 60 acquires the document data requested for printing from the portable telephone set 1, from the document DATDB 24 of the printing server 2 via Internet at the above step ST126, the controller produces a record in a temporary storage buffer 663 (ST131). At this time, the controller 141 stores a file name as a blank, the requested time as the current time, and the deletion time as a blank. Then, the controller 141 acquires a contact from the printing server user management DB 25 via Internet 6.

The controller 141 converts a document requested for printing into information immediately before printing, and defines the document as a temporary file (ST132). For example, the controller converts the sample data (document) shown in FIG. 49 into a PS file.

The controller 141 updates the record produced in the temporary storage buffer 63 at the step ST131, and defines the file name as a file name of the temporary file generated at the step ST132 (ST133).

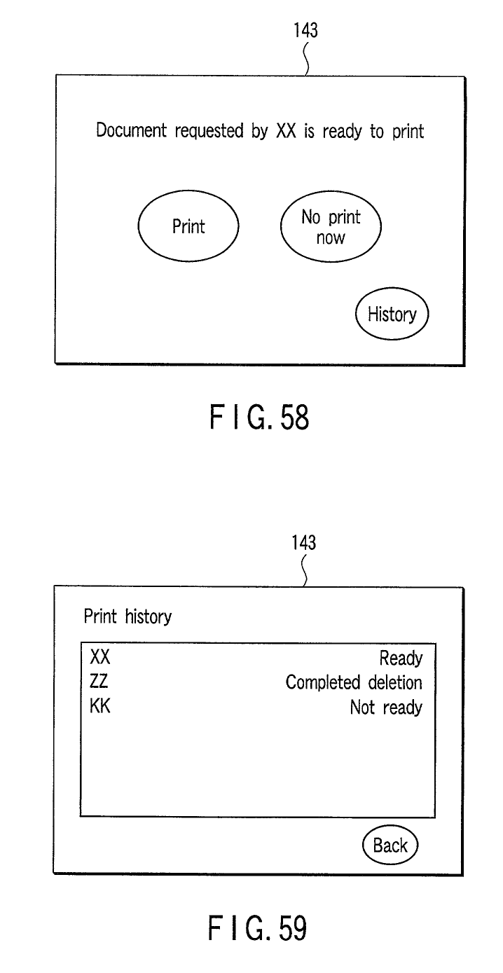

The controller 141 displays a message at the display section 143 (ST144). FIG. 58 shows an example of a message displayed at this display section 143. In this example, the message “Document(a) requested from XX is(are) ready for printing” is displayed, the buttons “Print” and “No printing now” are provided, and further, the button “history” is provided.

Then, the controller waits for the user input (ST145).

When the button “Print” is pressed (ST146), the controller 141 prints a temporary file updated in the temporary storage buffer 63 by the printer 147 (ST147). Then, the controller deletes the record (including a temporary file) from the temporary storage buffer 63.

In addition, when the button “No printing now” is pressed (ST146), the controller 141 restores the display screen of the display section 143 (ST148).

In addition, after the button “History” displayed at the display section 143 shown in FIG. 58 has been pressed, when the history is called, the controller 141 displays data (document) stored in the temporary storage buffer 63. FIG. 59 shows an example when the data (document) is displayed as a printing history. For example, “XX: Ready”, “ZZ: Completed deletion”, and “KK: Not ready” are displayed. The button “back” is provided as well.

A state of data (document) stored in the temporary storage buffer 63 is determined as follows.

Condition 1. If a file name and a deletion time are blanked, the content displayed as a document state is “Not ready”.

Condition 2. If only the deletion time is blanked, “Ready” is displayed.

Condition 3. If the deletion time is not blanked, “Completed deletion” is displayed.

Further, apart from the above, the following processing is periodically initiated.

The controller 141 searches the temporary storage buffer 63. If the current time and requested time are defined as a record whose value is greater than a predetermined value and if a file name is not blanked, the controller deletes a temporary file indicated by that file name and the file name of the record is blanked to insert the current time to the deletion time.

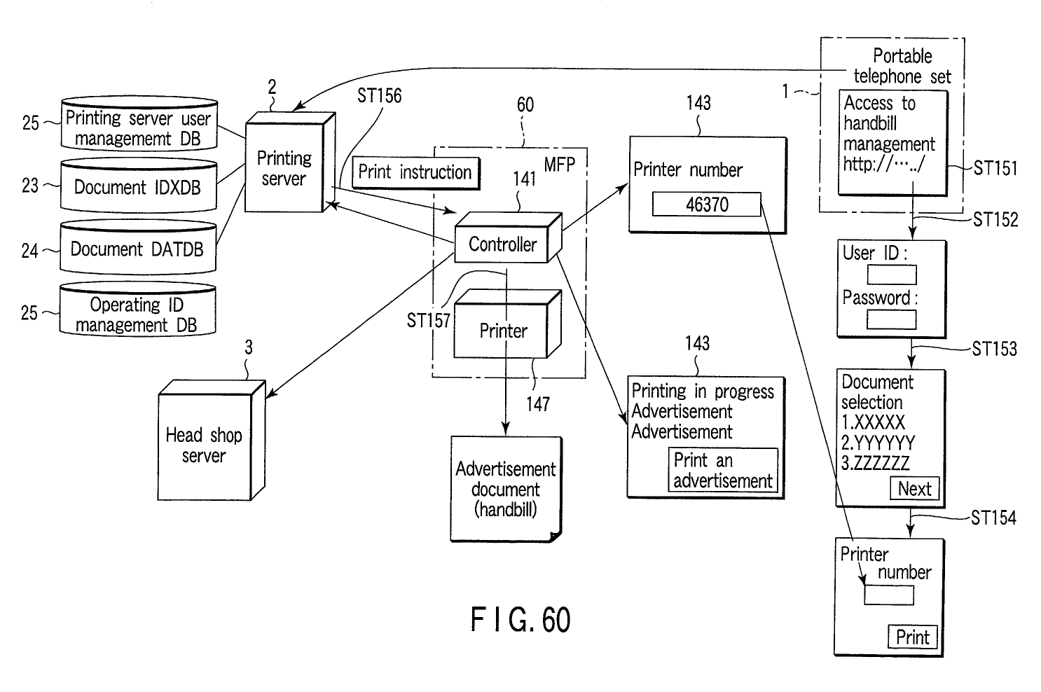

Now, an operation for inputting the printer number displayed at the display section 147 of the MFP 60, and specifying printing will be described with reference to the flow chart of FIG. 60.

First, the controller 141 of the MFP 60 periodically rewrites the identification code assigned to the device (for example, every five minutes) into the printing server 2 that manages the device. This operation is accomplished by assigning the device ID from the controller 141, and periodically making inquiry to the printing server 2 via Internet 6.

The controller 121 of the printing server 2 generates the identification code that does not exists in the device ID management DB 22 in response to this inquiry, and returns the code to the controller 141 of the MFP 60 via Internet 6. Then, as shown in FIG. 10, the controller 121 defines the due date as the current time+α as shown in FIG. 10 and stores the identification code generated together with device ID in the device ID management DB 22. “α” may be equal to or greater than the rewrite interval (such as 8 minutes=5 minutes+3 minutes, for example). If a record at which this due date has expired exists, such record is displayed.

The controller 141 of the MFP 60 displays the identification code (printer number) returned from the printing server 2 at the display section 143.

In such a state, the user checks the contents displayed at the display section 12 by opening the E-mail received in advance by the portable telephone set 1 (ST151).

When a user operates a link displayed from the operating section 13, login to the printing server 2 is requested. The control section 11 of the portable telephone set 1 displays the “user ID” and “password” at the display section 12 (ST152).

This operation may be omitted by providing the user ID or password in advance in a link. As a result, “http://Shop.com/Login.cgi?User=suzuki&password=XXX” or the like is shown.

The control section 11 of the portable telephone set 1 displays a list of documents (selected documents) owned by the user from the printing server 2 (ST153). Here, a desired print document is selected by the user.

When the document selection has terminated, the control section 11 displays a printer number (identification code) input screen of the MFP 60 that executes printing at the display section 12 (ST154). At this time, the user refers to a printer number (identification code) displayed at the display section 143 of the MFP 60, inputs that printer number (identification code) from the operating section 13 of the portable telephone set 1, presses the button “Print” (from the operating section 13), and instructs printing.

When the printer number (identification code) is inputted, and the button “Print” is pressed, the control section 11 transmits a request for printing a selected document (advertisement) to the printing server 2.

The controller 121 of the printing server 2 searches the device ID from the device ID management DB 22 by using the identification code contained in the print request transmitted from the portable telephone set 1 (ST155).

The controller 121 of the printing server 2 instructs printing of an advertisement document to the MFP 60 having the searched device ID via Internet 6 (ST156).

The controller 141 of the MFP 60 instructed for printing from the printing server 2 executes printing of an advertisement document at the printer 147 in accordance with the print instruction from the printing server 2 (ST157). The controller 141 displays “printing in progress” at the display section 143, as shown in FIG. 56, while printing the advertisement document, and acquires advertisement information from the shop internal advertisement DB 57 or the like to display “advertisement”. At this time, the advertisement can be printed by the button “Print advertisement”.

As shown in FIG. 9, the device ID management DB 22 may eliminate processing concerning due date. In addition, the identification code for the MFP 60 may not be displayed at the display section 143, and may be pasted to the MFP 60 by POP or the like.

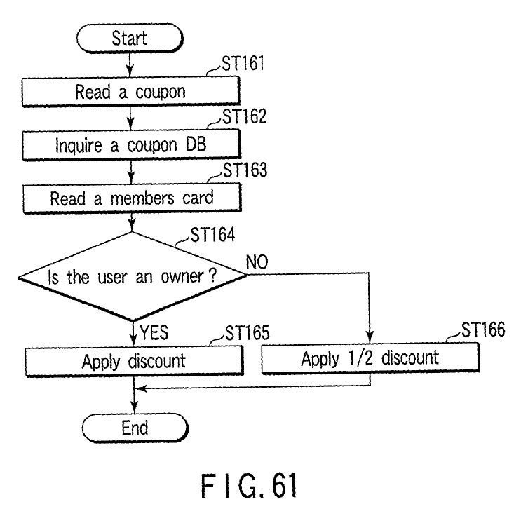

Now, an operation for checking the identification of a coupon user will be described with reference to the flow chart of FIG. 61.

First, the clerk at the shop 5 reads the user-presented coupon (bar code printed in the advertisement document) by the bar code reader device 54 of the POS processing section 53 (ST161).

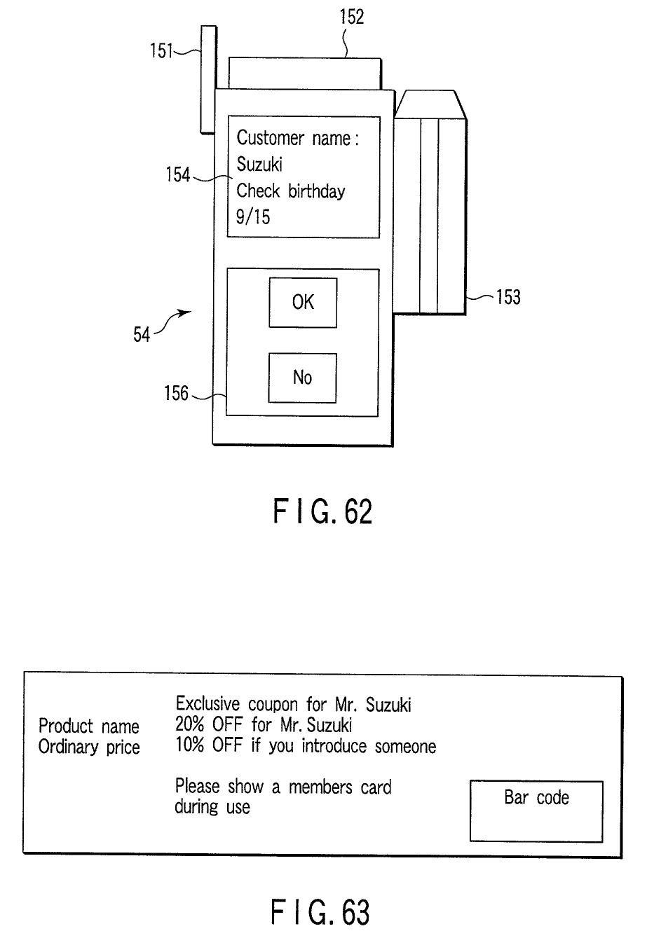

FIG. 62 shows an external configuration of the bar code reader device 54. This bar code reader device 54 is composed of: a wireless communication section 151 configured to communicate with POS processing section 53 using radio; a bar code reader 152 for reading a bar code; a display section 154 for displaying a variety of information; a card reader section 153 for reading magnetic information on cards; and an operating key section 156 for making a variety of operations and inputs including keys “OK” and “No”. At the step ST161, the bar code reader device 54 transmits bar code information read by the bar code reader 152 to the POS processing section 53 via a wireless communication section 151.

FIG. 63 shows an example of coupon printed in the above advertisement document. In the coupons, “exclusive coupon for Suzuki”, “20% Off for Suzuki”, or “10% OFF if you introduce somebody” is printed, and the preferential application of discount rate is employed. Further, the “product name” to be discounted or the “usual price” or the like is printed. A message “Please show members card during use” is printed for identification. The bar code composed of information such as coupon ID is printed.

The POS processing section 53 inquires the head shop server 3 as to the bar code information (coupon ID) of the received coupon via Internet 6 (ST162).

The controller 131 of the head shop server 3 searches the coupon DB 36 from the inquired coupon ID (bar code information on coupon), acquires the members card number, discount rate and the like, and returns it to the POS processing section 53 of the shop 5 via Internet 6.

In addition, the clerk of the shop 5 further reads the members card which is shown by the user by a bar code reader device 54 (card reader section 153 or bar code reader 152) (ST163). The bar code reader device 54 transmits the information (members card number) on the read members card to the POS processing section 53 from the wireless communication section 151.

The POS processing section 53 compares the received members card number with the members card number returned from the head shop server 3, and checks whether or not the user of the above coupon is an owner (coupon issuer) (ST164). When these members card numbers coincide with each other, it is determined that the user is the owner.

Where the user is the owner, the POS processing section 53 applies the returned discount rate from the head shop server 3 (ST165). If the user is not the owner, ½ of the discount rate returned from the head shop server 3 is applied (ST166).

Now, an embodiment when the present advertisement transmission system has been applied to a ticket will be described here.

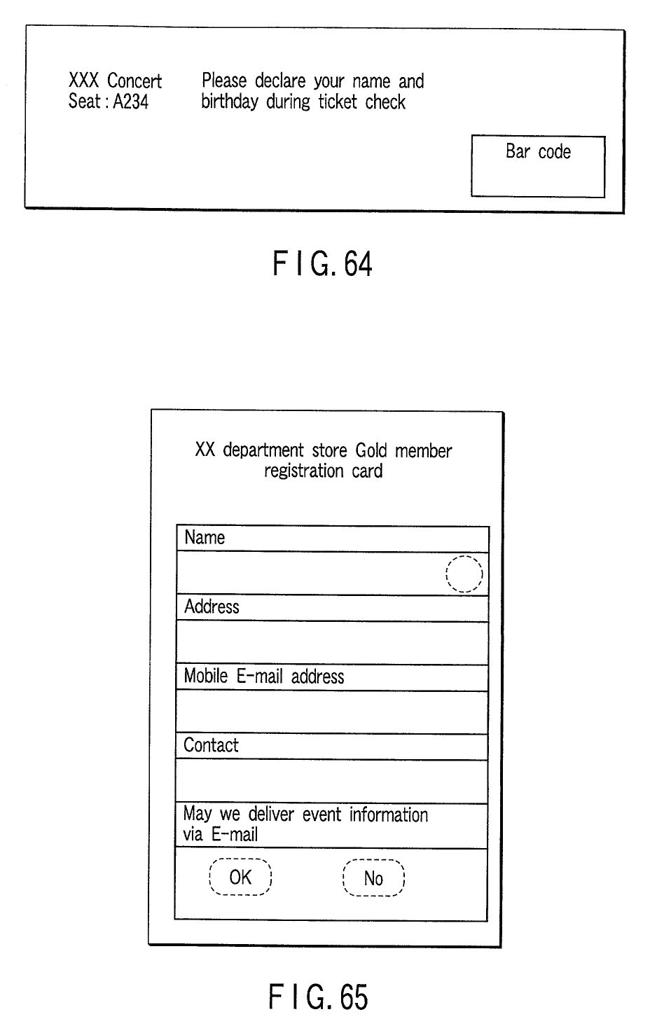

FIG. 64 shows an example of a printed ticket. In this ticket, there are printed “XXX concert”, “Seat A234”, and “Please declare your name and birthday during ticket check”, and a bar code composed of ticket number or the like is printed.

In this case, the POS processing section 53 and bar code reader device 54 shown in FIG. 1 are installed at the theater.

First, the clerk at the theater reads the bar code of the ticket shown by the user by using the bar code reader device 54 of the POS processing section 53. The bar code reader device 54 transmits the read bar code information (ticket number) from the wireless communication section 151 to the POS processing section 53. Here, the ticket number is defined as “A234”, for example.

The POS processing section 53 inquires bar code information (ticket number example: A234) to the head shop server 3 via Internet 6.

The controller 131 of the head shop server 3 searches the ticket DB 38 from the inquired ticket number (ticket bar code information) “A234”, acquires the customer's name, birth day and the like, and returns them to the POS processing section 53 of the theater via Internet 6. The controller searches the ticket DB 38 from “A234”, acquires the customer's name and birthday or the like, and returns them to the POS processing section 53 of the theater via Internet 6. The controller 131 checks whether the ticket is used or not at the same time in the field “used”. If the ticket number has been used, the fact is returned to the POS processing section 53.

The POS processing section 53 transmits information such as customer's name or birthday that corresponds to the returned ticket number to the bar code reader device 54. For example, the ticket number “A234” in the ticket DB 38 shown in FIG. 31 includes the customer's name “suzuki” and birthday “September 15”.

The bar code reader device 54 displays information such as received customer's name or birthday at the display section 154. Then, the clerk at the theater inquires the customer's name and birthday to the customer, and checks the identity.

When the identity is correctly checked, the clerk at the theater presses the key “OK” at the operating key section 156. By pressing the key “OK”, the bar code reader device 54 transmits information indicating that a ticket of the ticket number (seat) has been used to the POS processing section 53 via the wireless communication section 151.

The POS processing section 53 transmits the information indicating that a ticket of the received ticket number (seat) has been used to the head shop server 3 via Internet 6.

The controller 131 of the head shop server 3 having received the fact that a ticket of the ticket number (seat) has been used, changes the “used” field of the ticket number of ticket DB38 from “TRUE” to “FALSE”. For example, for the ticket number “A234” in the ticket DB 38 shown in FIG. 31, the “used” field is changed to “FALSE”.

Now, an operation for an unrecorded user will be described here.

First, in the present embodiment, there is described a case where the contents of a homepage of the shop described at the step ST14 in FIG. 44 are read out without starting from E-mail reception because of an unrecorded user.

The head shop server 3 instructs the portable telephone set 1 of the user to carry out E-mail transmission.

The user transmits E-mail from the portable telephone set 1 to the printing server 2 according to the E-mail transmission instruction.

The controller 121 of the printing server 2 having received the above E-mail searches the printing server user management DB 25 by using a user name contained in such E-mail. However, this user name does not exist, and thus, the user ID (user name) is newly generated. At this time, the controller 121 newly generates the user ID and password, and further, instructs the head shop server 3 to generate an advertisement document (advertisement document oriented to a general person).

The controller 131 of the head shop server 3 searches the head shop user management DB 31 by using the user ID (user name) contained in such instruction for generating the received advertisement document. However, this user name does not exist, and thus, is defined as an unrecorded person. Then, advertisement statement data is acquired from the unrecorded person oriented advertisement statement DB 58 shown in FIG. 35 via Internet, and is transmitted to the printing server 2.

The controller 121 of the printing server 2 stores the received advertisement statement data in the document IDXDB 23 and document DATDB 24, and transmits the generated user ID and password to the head shop server 3 via Internet 6. At this time, the controller attaches a link of a user detail registration page.

The controller 131 of the head shop server 3 stores the received user ID and password in the head shop user management DB 31.

Now, a description will be given with respect to a case where an advertisement document is printed from the MFP 60 installed at the shop 5.

Where an unrecorded person prints an advertisement document, the user causes the display section 143 of the MFP 60 to initially display a use key from a menu screen (not shown), and presses this use key. In this manner, the controller 141 of the MFP 60 reads out unrecorded person advertisement document data from the document IDXDB 23 and document DATDB 24 of the printing server 2 via Internet 6, and executes printing by the printer 147. At this time, the controller 141 prints out a “membership registration card” shown in FIG. 65 at the same time.

Now, accounting in the printing server 2 will be described here.

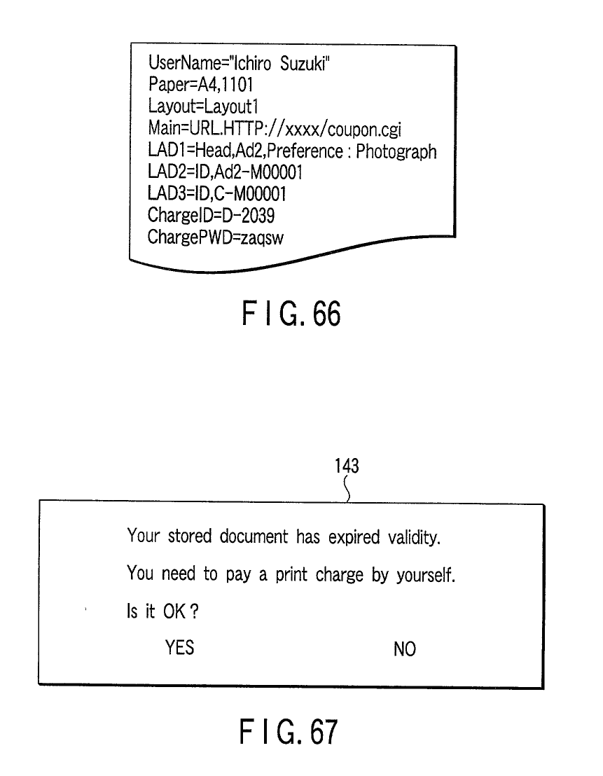

FIG. 66 shows an example of document data stored in the document DATDB 24 of the printing server 2. In the figure, “ChargeID” and “ChargePWD” are assigned. Here, “ChargeTime” is ignored.

In addition, “Mail” is specified as “URL,HTTP://xxxx/coupon.cgi”. In the present embodiment, when the MFP 60 prints this document data, it denotes that print data is acquired by inquiring “HTTP://xxxx/coupon.cgi”. Of course, print data may be held in document data stored in the printing server 2.

The payer ID management DB 27 managed in the printing server 2 is as shown in FIG. 20. This database stores the payer ID and password.

In the present embodiment, the validity is set for a case where an attempt is made to sometimes change a password. This validity is rejected in a case where the validity of a record whose passwords are coincident with each other does not include the current time when printing is carried out by the MFP 60. In such a case, the controller 141 of the MFP 60 displays a message as shown in FIG. 67 at the display section 143 for the user. In a display example shown in FIG. 67, a message “your stored document has expired the validity, You have to pay a printing charge by oneself. Is it OK?”, a key “YES” and a key “NO” are displayed. In this manner, the payer can burden a print charge only within the validity.

For example, this information includes event information or the like which is invalid if printing is carried out if a predetermined due date has expired. In addition, at a person who manages the printing server 2 as well, it is possible to prevent printing if a payer cancels a contract.

In addition, as has been already described with reference to FIG. 14 to FIG. 19, the accounting DB 26 is configured. A description will be given by way of example in which a document is printed, the document being stored in line 3 in the user charge detail table 26d shown in FIG. 17. In this example, settlement type includes “substitute”, and settlement detail information includes “D-2039”. “CharageID=D-2039” in a document being sample data shown in FIG. 66 is stored as settlement detail information.

In addition, in summation of charges by payers, the printing time applied to the settlement period is provided for the user charge detail. Then, a search is made for a record whose settlement type is “settlement”, and the settlement detail information, accounting type, and summation of counts are outputted to the result. At this time, the settlement detail information and accounting type are sorted in order for clarity.

Now, management of a destination of delivering a gift will be described here.

If the user delivered the gift at the shop (including associated shop) 5 in the past, the delivery destination is managed for each user. For example, for sales of a year ending gift, the corresponding information is printed. That is, if the user delivered the gift at the shop (including associated shop), the history is managed for each user. Then, the delivery destination is categorized, and products being a candidate by category and the delivery destination and history included in the category are printed (for example, one piece per category). Serial numbers such as A, B, and C (abbreviated delivery destination) are printed for the delivery destination, and a space for entering the abbreviated delivery destination is provided for each product. For example, the price (customers for 3,000 Yen, 5,000 Yen, and 10,000 Yen), classical menu, food or the like is available as a category candidate.

By using the order sheet input terminal 70 shown in FIG. 1, after the customer has entered the order sheet, the bar code reader 71 reads the advertisement ID of the advertisement document. In this manner, the order sheet input terminal 70 displays an input screen on the touch panel 72. Then, the clerk inputs the information entered in the advertisement document from the touch panel 72.

The above order sheet may be configured by the clerk reading entries by using an OCR or OMR so that the written order sheet check is printed.

As has been described above, according to the above embodiments of the present invention, the shop can transmit event information such as sales by E-mail PUSH whenever and whatever necessary.

The user's attention can be attracted by carrying out such PUSH transmission.

In addition, where the user has interest in this sales, the user can print an advertisement document (handbill) when one visits the shop.

Further, the customer's preference or inventory state can be reflected in order to produce detail data (print image) of an advertisement document (handbill) during this printing.

At this time, individual exclusive coupons or the like can be printed. This makes it necessary to link with a POS system by using a bar code. At this time, this makes it necessary to include a very large amount of data such as customer's number in a bar code. Therefore, in the present invention, all of these items of information are stored in a database, and an ID (coupon ID) is assigned to such information. The assigned ID is embedded as a bar code, thus making it possible to readily achieve the POS system.

The present invention is not limited to each of these embodiments. The present invention cannot be modified variously without departing from the spirit of the invention at its stage of embodiment. In addition, these embodiments each may be carried out by combining them to the possible maximum. In this case, the combined effect can be obtained. Further, the inventions at various stages are included in the above embodiments, and a variety of inventions can be excerpted by using a proper combination in a plurality of disclosed constituent elements. For example, even if some of all the constituent elements presented in the embodiments are deleted, where the problems described in the Field of the Invention section can be solved, and advantageous effects described in the Detailed Description of the Invention can be achieved, a configuration of which these constituent elements have been deleted can be excerpted as an invention.

What is claimed is:

1. An advertisement transmitting system in which a first device which makes communication with a portable terminal, a second device which has print data registered therein, and a printer device which has a communication function and carries out printing are connected to each other via a communication line, the first device comprising:
a storage section which stores advertisement information which produces an advertisement that contains image information;
a production section which produces advertisement data that contains advertisement document information to be transmitted to the portable terminal by using advertisement information stored in the storage section; and
a transmission section which transmits advertisement data produced by the production section to the portable terminal via the communication line;
the second device comprising:
a receiving section which receives a request for printing an advertisement document contained in the advertisement data from the portable terminal via the communication line;
an acquiring section which acquires print data that corresponds to a request for printing an advertisement document received at the receiving section from advertisement information stored in the storage section via the communication line; and
a registering section which registers print data acquired by the acquiring section,
the printer device comprising:
an accepting section which accepts a request for printing the advertisement document;
a readout section which reads out print data registered in the registering section according to a request for printing an advertisement document accepted by the accepting section; and
a printing section which prints print data read out by the readout section.

2. An advertisement transmitting system according to claim 1, wherein the storage section stores advertisement information in response to advertisement identification information.

3. An advertisement transmitting system according to claim 1, wherein the production section uses advertisement layout information, advertisement type information, and profile information added to address information on the transmitting portable telephone set, thereby producing advertisement data.

4. An advertisement transmitting system according to claim 1, wherein the transmission section transmits E-mail.

5. An advertisement transmitting system according to claim 1, wherein a portable terminal to which the transmission section transmits advertisement data is registered in advance.

6. An advertisement transmitting system according to claim 1, wherein the printer device is installed at a shop.

7. An advertisement transmitting system according to claim 1, wherein the accepting section accepts a request for printing an advertisement document by making operation from an operating section provided at the printer device.

8. An advertisement transmitting system according to claim 1, wherein the accepting section accepts a request for printing an advertisement document delivered from the portable telephone set via wireless communication.

9. An advertisement transmitting system according to claim 1, wherein the accepting section having received the request for printing the advertisement document carries out individual authentication.

10. An advertisement transmitting system in which a first device which makes communication with a portable terminal, a second device which has print data registered therein, and a printer device which has a communication function and carries out printing are connected to each other via a communication line, the first device comprising:
a storage section which stores advertisement information which produces an advertisement that contains image information;
a first production section which produces advertisement data that contains advertisement document information to be transmitted to the portable terminal by using advertisement information stored in the storage section;
a first transmission section which transmits advertisement data produced by the production section to the portable terminal via the communication line;
a first receiving section which receives via the communication line a request for printing an advertisement document contained in the advertisement data from the portable terminal;
a second production section which produces print data in response to the request for printing the advertisement document received at the first receiving section from the advertisement information stored in the storage section; and
a second transmission section which transmits the print data produced at the second production section to the second device,
the second device comprising:
a second receiving section which receives print data transmitted from the second transmission section; and
a registering section which registers the print data received from the second receiving section,
the printer device comprising:
an accepting section which accepts the request for printing the advertisement document;
a readout section which reads out the print data registered in the registering section in response to the request for printing the advertisement document accepted by the accepting section; and
a printing section which prints the print data read out at the readout section.

11. An advertisement transmitting system in which a first device which makes communication with a portable terminal, a second device which has print data registered therein, and a printer device which has a communication function and carries out printing are connected to each other via a communication line, the first device comprising:
a storage section which stores advertisement information which produces an advertisement that contains image information;
a production section which produces advertisement data that contains advertisement document information to be transmitted to the portable terminal by using advertisement information stored in the storage section; and
a first transmission section which transmits advertisement data produced by the production section to the portable terminal via the communication line;
the second device comprising:
a receiving section which receives a request for printing an advertisement document contained in the advertisement data from the portable terminal via the communication line;
an acquiring section which acquires print data that corresponds to a request for printing an advertisement document received at the receiving section from advertisement information stored in the storage section via the communication line;
a registering section which registers print data acquired by the acquiring section, a second transmission section which, after registering print data at the registering section, produces identification information and a password, followed by transmitting the identification information and password to the portable terminal via the communication line; and
a control section which carries out control for storing the identification information and password transmitted at the second transmission section, compares the information and password with the identification information and password transmitted from the printer device, determines whether or not the request for printing the advertisement document can be made, and notifies the fact to the printer device,
the printer device comprising:
an accepting section which accepts a request for printing the advertisement document;
a request section which, when the accepting section has accepted the request for printing the advertisement document, requests input of the identification information and password;
a third transmission section which transmits the identification information and password inputted in response to a request of the request section to the second device;
a readout section which, when a notification that the request for printing the advertisement document is enabled has been received from the second device in response to the identification information and password transmitted by the third transmission section, reads out print data registered in the registering section according to the request for printing an advertisement document received by the accepting section; and
a printing section which prints print data read out by the readout section.

12. An advertisement transmitting system in which an information processing device which makes communication with a portable terminal and a printer device which has a communication function, the printer device carrying out printing, are connected to each other via a communication line, the printer device comprising:
a receiving section which receives a coupon print request from the portable terminal via the communication line; and
a control section which adds coupon information in response to the coupon print request received by the receiving section, followed by controlling coupon printing,
the information processing device comprising:
a reading section which reads coupon information added to the coupon printed under the control of the control section; and
a processing section which carries out processing based on the coupon information read by the reading section.

13. An advertisement transmitting system according to claim 12, wherein the receiving section receives a coupon print request from the portable terminal via Internet.

14. An advertisement transmitting system according to claim 12, wherein the coupon information printed after controlled by the control section is a bar code.

15. An advertisement transmitting system according to claim 12, wherein the reading section is a bar code reader which optically reads data.

16. An advertisement transmitting system in which an information processing device which makes communication with a portable terminal and a printer device which has a communication function, the printer device carrying out printing, are connected to each other via a communication line, the printer device comprising:
a receiving section which receives a ticket print request from the portable terminal via the communication line; and
a control section which adds authentication information in response to the ticket print request received by the receiving section, followed by controlling ticket printing,
the information processing device comprising:
a reading section which reads authentication information added to the ticket printed under the control of the control section; and
a display section which displays the authentication information read by the reading section.

17. An advertisement transmitting system according to claim 16, wherein the information processing device is provided at a facility such as theater where one can enter by the ticket.

18. An advertisement transmitting system according to claim 16, wherein the authentication information added to the control section is a customer's name and birthday.
